(19) United States
(12) Patent Application Publication
(10) Pub. No.: US 2026/0113781 A1
(43) Pub. Date: Apr. 23, 2026

(54) BEAM SELECTION WITH RANDOM ACCESS

(71) Applicant: QUALCOMM Incorporated, San Diego, CA (US)

(72) Inventors: In-Soo KIM, San Diego, CA (US); Yan ZHOU, San Diego, CA (US); Jing SUN, San Diego, CA (US); Jing JIANG, San Diego, CA (US)

(21) Appl. No.: 18/920,802

(22) Filed: Oct. 18, 2024

(51) Int. Cl. H04W 74/0833; H04B 7/08; H04W 52/18

(52) U.S. Cl. CPC H04W 74/0833; H04B 7/088; H04W 52/18

(57) ABSTRACT

Various aspects of the present disclosure generally relate to wireless communication. Some aspects more specifically relate to an early user equipment (UE) beam refinement scheme during initial access using msg1 repetition. In some aspects, a UE may beam-sweep an initial message of a random access procedure over respective UE narrow beams within an initial UE wide beam. A network node may select one of the UE narrow beams and transmit an indication of the selected UE narrow beam to the UE. The UE may then use the UE narrow beam for subsequent uplink and/or downlink communications.

### FIELD OF THE DISCLOSURE

Aspects of the present disclosure generally relate to wireless communication and specifically relate to techniques, apparatuses, and methods associated with beam selection with random access.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to an apparatus for wireless communication at a user equipment (UE). The apparatus may include a processing system that includes one or more processors and one or more code-storing memories coupled with the one or more processors. The processing system may be configured to cause the UE to receive one or more beam sweeping signals via one or more respective network beams. The processing system may be configured to cause the UE to transmit a plurality of first random access messages via respective UE beams associated with a network beam of the one or more respective network beams. The processing system may be configured to cause the UE to receive an indication of a UE beam of the respective UE beams.

Some aspects described herein relate to an apparatus for wireless communication at a network node. The apparatus may include a processing system that includes one or more processors and one or more code-storing memories coupled with the one or more processors. The processing system may be configured to cause the network node to transmit one or more beam sweeping signals via one or more respective network beams. The processing system may be configured to cause the network node to receive a plurality of first random access messages via respective UE beams associated with a network beam of the one or more respective network beams. The processing system may be configured to cause the network node to transmit an indication of a UE beam of the respective UE beams.

Some aspects described herein relate to a method for wireless communication by a UE. The method may include receiving one or more beam sweeping signals via one or more respective network beams. The method may include transmitting a plurality of first random access messages via respective UE beams associated with a network beam of the one or more respective network beams. The method may include receiving an indication of a UE beam of the respective UE beams.

Some aspects described herein relate to a method for wireless communication by a network node. The method may include transmitting one or more beam sweeping signals via one or more respective network beams. The method may include receiving a plurality of first random access messages via respective UE beams associated with a network beam of the one or more respective network beams. The method may include transmitting an indication of a UE beam of the respective UE beams.

Some aspects described herein relate to an apparatus for wireless communication. The apparatus may include means for receiving one or more beam sweeping signals via one or more respective network beams. The apparatus may include means for transmitting a plurality of first random access messages via respective UE beams associated with a network beam of the one or more respective network beams. The apparatus may include means for receiving an indication of a UE beam of the respective UE beams.

Some aspects described herein relate to an apparatus for wireless communication. The apparatus may include means for transmitting one or more beam sweeping signals via one or more respective network beams. The apparatus may include means for receiving a plurality of first random access messages via respective UE beams associated with a network beam of the one or more respective network beams. The apparatus may include means for transmitting an indication of a UE beam of the respective UE beams.

Some aspects described herein relate to a non-transitory computer-readable medium that stores a set of instructions for wireless communication by a UE. The set of instructions, when executed by one or more processors of the UE, may cause the UE to receive one or more beam sweeping signals via one or more respective network beams. The set of instructions, when executed by one or more processors of the UE, may cause the UE to transmit a plurality of first random access messages via respective UE beams associated with a network beam of the one or more respective network beams. The set of instructions, when executed by one or more processors of the UE, may cause the UE to receive an indication of a UE beam of the respective UE beams.

Some aspects described herein relate to a non-transitory computer-readable medium that stores a set of instructions for wireless communication by a network node. The set of instructions, when executed by one or more processors of the network node, may cause the network node to transmit one or more beam sweeping signals via one or more respective network beams. The set of instructions, when executed by one or more processors of the network node, may cause the network node to receive a plurality of first random access messages via respective UE beams associated with a network beam of the one or more respective network beams. The set of instructions, when executed by one or more processors of the network node, may cause the network node to transmit an indication of a UE beam of the respective UE beams.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example disaggregated network node architecture in accordance with the present disclosure.

FIG. 3 is a diagram illustrating an example of a four-step random access procedure in accordance with the present disclosure.

FIG. 4 is a diagram illustrating examples of channel state information reference signal beam management procedures in accordance with the present disclosure.

FIG. 5 is a diagram illustrating an example of aperiodic P2 and/or P3 beam refinement for idle user equipment (UE) initial access in multi-beam operation in accordance with the present disclosure.

FIG. 6 is a diagram illustrating an example of network node beam refinement via msg1 repetition in accordance with the present disclosure.

FIG. 7 is a diagram illustrating an example associated with signaling for beam selection with random access in accordance with the present disclosure.

FIG. 8 is a diagram illustrating an example associated with UE beam refinement via msg1 repetition in accordance with the present disclosure.

FIG. 9 is a diagram illustrating an example associated with random access channel occasions (ROs) in accordance with the present disclosure.

FIG. 10 is a diagram illustrating an example associated with transmit power in accordance with the present disclosure.

FIG. 11 is a diagram illustrating an example associated with random access failure in accordance with the present disclosure.

FIG. 12 is a diagram illustrating an example associated with RO allocation in accordance with the present disclosure.

FIG. 13 is a diagram illustrating an example associated with RO indexes in accordance with the present disclosure.

FIG. 14 is a diagram illustrating an example associated with UE beam refinement via msg1 repetition for primary secondary cell activation by a primary cell in accordance with the present disclosure.

FIG. 15 is a flowchart illustrating an example process performed, for example, at a UE or an apparatus of a UE that supports beam selection with random access in accordance with the present disclosure.

FIG. 16 is a flowchart illustrating an example process performed, for example, at a network node or an apparatus of a network node that supports beam selection with random access in accordance with the present disclosure.

FIG. 17 is a diagram of an example apparatus for wireless communication that supports beam selection with random access in accordance with the present disclosure.

FIG. 18 is a diagram of an example apparatus for wireless communication that supports beam selection with random access in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A network node may transmit a synchronization signal block (SSB) communication to provide control information to a user equipment (UE). For example, the network node may transmit the SSB communication to convey a primary synchronization signal (PSS), a secondary synchronization signal (SSS), and a physical broadcast channel (PBCH), among other examples. A UE may perform an initial access procedure, such as a random access channel (RACH) procedure, to obtain access to network services. For example, the UE may receive an SSB (as well as a system information block (SIB), such as SIB1) conveying control information and may transmit an initial message (for example, msg1 or msgA) of a RACH procedure (for example, a four-step or two-step RACH procedure) to trigger the RACH procedure and obtain resources for communication.

In some examples, an initial access procedure may enable a network node to determine a network wide beam and a UE to determine a UE wide beam. However, the network wide beam and the UE wide beam may provide limited transmission success. Accordingly, the network node and UE may perform a network beam refinement process, which may yield a refined network beam that is narrower than the network wide beam, and a UE beam refinement process, which may yield a refined UE beam that is narrower than the UE wide beam. However, performing the initial access procedure, the network beam refinement process, and the UE beam refinement process sequentially may contribute to excessive latency. Accordingly, the network beam refinement process may be integrated with the initial access procedure, which may help to reduce latency to an extent. However, integrating the network beam refinement process, instead of the UE beam refinement process, with the initial access procedure may contribute to excessive delays in establishing the refined UE beam.

Various aspects relate generally to early UE beam refinement. Some aspects more specifically relate to an early UE beam refinement scheme during initial access using msg1 repetition. In some aspects, the UE may beam-sweep msg1s over respective UE narrow beams within an initial UE wide beam. The network node may select one of the UE narrow beams and transmit an indication of the selected UE narrow beam to the UE. The UE may then use the selected UE narrow beam for subsequent uplink and/or downlink communications. In some aspects, the early UE beam refinement scheme may be implemented instead of, or in addition to, an early network beam refinement process.

In some aspects, the early UE beam refinement scheme may involve both a downlink refined UE beam and an uplink refined UE beam. For example, the UE may transmit a first set of msg1s for downlink UE beam selection and a second set of msg1s for uplink UE beam selection.

Particular aspects of the subject matter described in this disclosure can be implemented to realize one or more of the following potential advantages. In some examples, the described techniques can be used to reduce delays associated with UE beam refinement by enabling early UE beam refinement during random access. For example, the early UE beam refinement scheme may reduce a quantity of SSB transmissions and instead refine the UE wide beam by sweeping UE narrow beams across multiple msg1 transmissions.

The early UE beam refinement scheme involving both a downlink refined UE beam and an uplink refined UE beam may help to improve downlink and/or uplink transmission success rates, such as in examples where a highest-quality downlink beam and a highest-quality uplink beam are different beams (for example, in examples involving maximum permissible exposure (MPE) requirements that may constrain certain uplink transmission parameters).

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

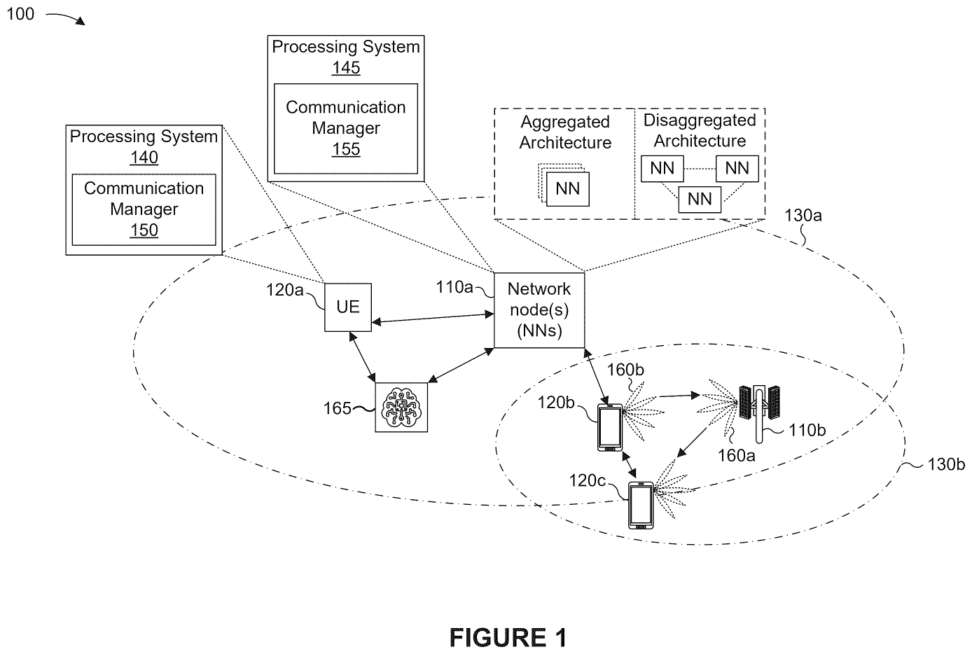

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

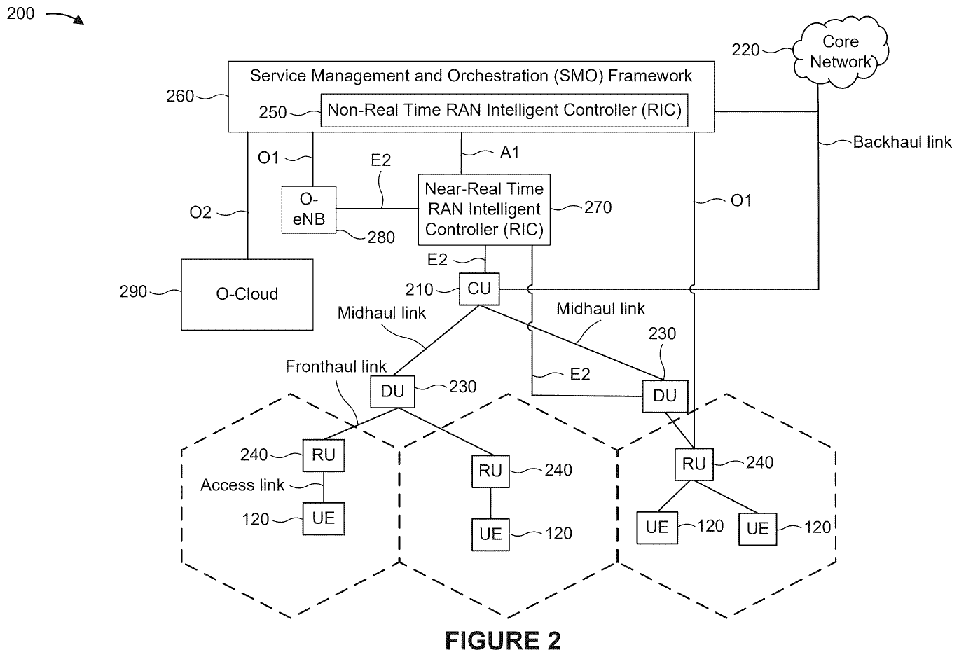

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry, a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a PSS, a SSS, an SS block (SSB) (for example, that includes a PSS, an SSS, and a PBCH), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a medium access control (MAC) control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a RACH operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Further efficiencies in throughput, signal strength, and/or other signal properties may be achieved through beam refinement. For example, the network node 110 may be capable of communicating with the UE 120 using beams (for example, beam(s) 160a) of different beam widths. In some examples, the network node 110 may be configured to utilize a wider beam to communicate with the UE 120 when the UE 120 is in motion or for initial beam acquisition because wider coverage may increase the likelihood that the mobile UE 120 remains in coverage of the network node 110 while communicating using the wider beam. Conversely, the network node 110 may use a narrower beam to communicate with the UE 120 when the UE 120 is stationary because the network node 110 can reliably focus coverage on the UE 120 with low or minimal likelihood of the UE 120 moving out of the coverage area of the narrower beam. In some examples, to select a particular beam (for example, from the beam(s) 160a) for communication with a UE 120, the network node 110 may transmit a reference signal, such as an SSB or a CSI-RS, on each of a plurality of beams in a beam-sweeping manner. In some examples, SSBs may be transmitted on wider beams, whereas CSI-RSs may be transmitted on narrower beams. The UE 120 may measure the RSRP or the signal-to-interference-plus-noise ratio (SINR) on each of the beams and transmit a beam measurement report (for example, a Layer 1 (L1) measurement report) to the network node 110 indicating the RSRP or SINR associated with each of one or more of the measured beams. The network node 110 may then select the particular beam for communication with the UE 120 based on the L1 measurement report. In some other examples, when there is channel reciprocity between the uplink and the downlink, the network node 110 may derive the particular beam to communicate with the UE 120 (for example, on both the uplink and downlink) based on uplink measurements of one or more uplink reference signals, such as an SRS, transmitted by the UE 120.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may receive one or more beam sweeping signals via one or more respective network beams; transmit a plurality of first random access messages via respective UE beams associated with a network beam of the one or more respective network beams; and receive an indication of a UE beam of the respective UE beams. Additionally or alternatively, the communication manager 150 may perform one or more other operations described herein.

In some aspects, the network node 110 may include a communication manager 155. As described in more detail elsewhere herein, the communication manager 155 may transmit one or more beam sweeping signals via one or more respective network beams; receive a plurality of first random access messages via respective UE beams associated with a network beam of the one or more respective network beams; and transmit an indication of a UE beam of the respective UE beams. Additionally or alternatively, the communication manager 155 may perform one or more other operations described herein.

FIG. 2 is a diagram illustrating an example disaggregated network node architecture 200 in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

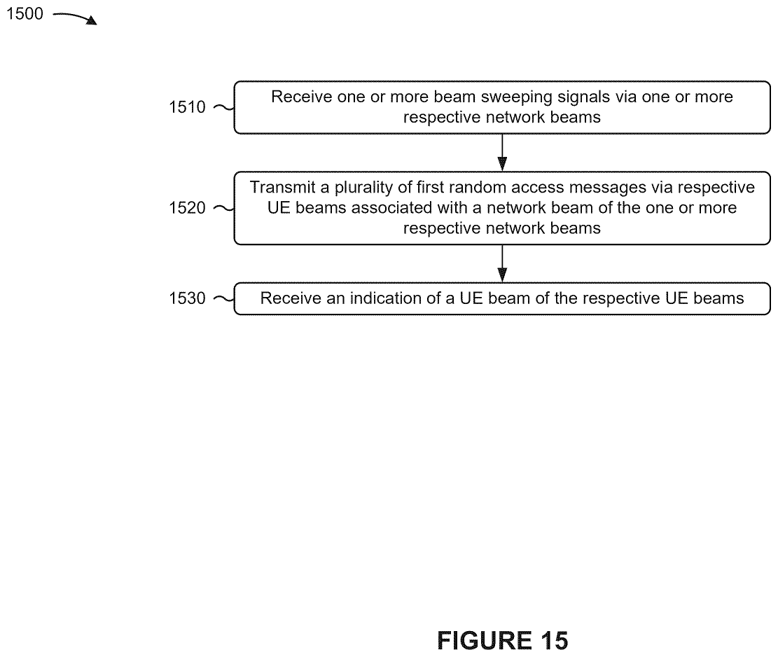

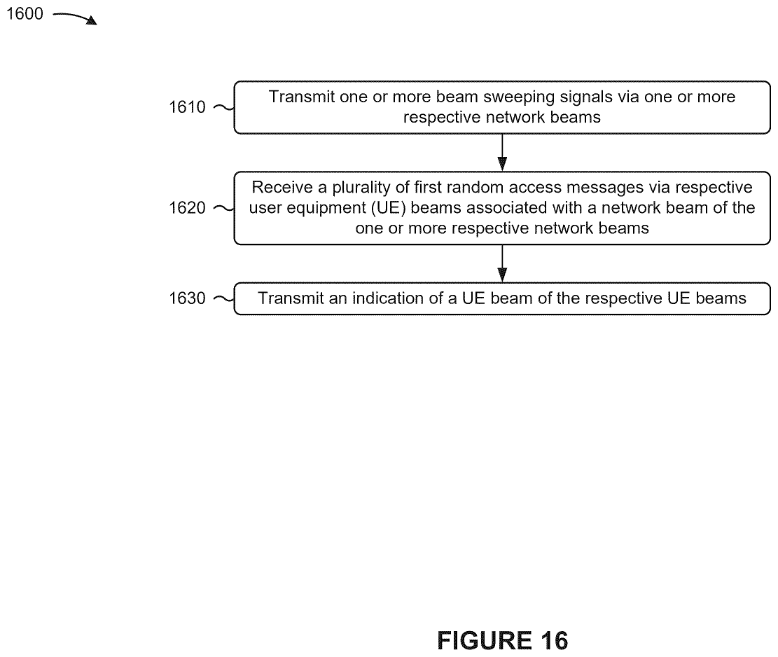

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with beam selection with random access, as described in more detail elsewhere herein. For example, the processing system 145 of the network node 110, the processing system 140 of the UE 120, the CU 210, the DU 230, or the RU 240 may perform or direct operations of, for example, process 1500 of FIG. 15, process 1600 of FIG. 16, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1500 of FIG. 15, process 1600 of FIG. 16, or other processes as described herein. In some examples, executing instructions may include running the instructions, converting the instructions, compiling the instructions, and/or interpreting the instructions, among other examples.

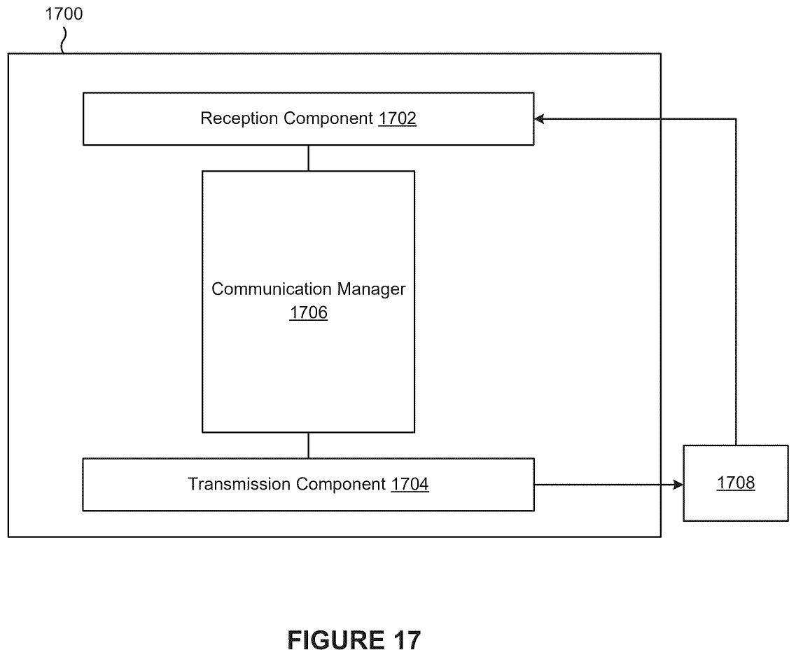

In some aspects, the UE 120 includes means for receiving one or more beam sweeping signals via one or more respective network beams; means for transmitting a plurality of first random access messages via respective UE beams associated with a network beam of the one or more respective network beams; and/or means for receiving an indication of a UE beam of the respective UE beams. The means for the UE 120 to perform operations described herein may include, for example, one or more of communication manager 150, processing system 140, a radio, one or more RF chains, one or more transceivers, one or more antennas, one or more modems, a reception component (for example, reception component 1702 depicted and described in connection with FIG. 17), and/or a transmission component (for example, transmission component 1704 depicted and described in connection with FIG. 17), among other examples.

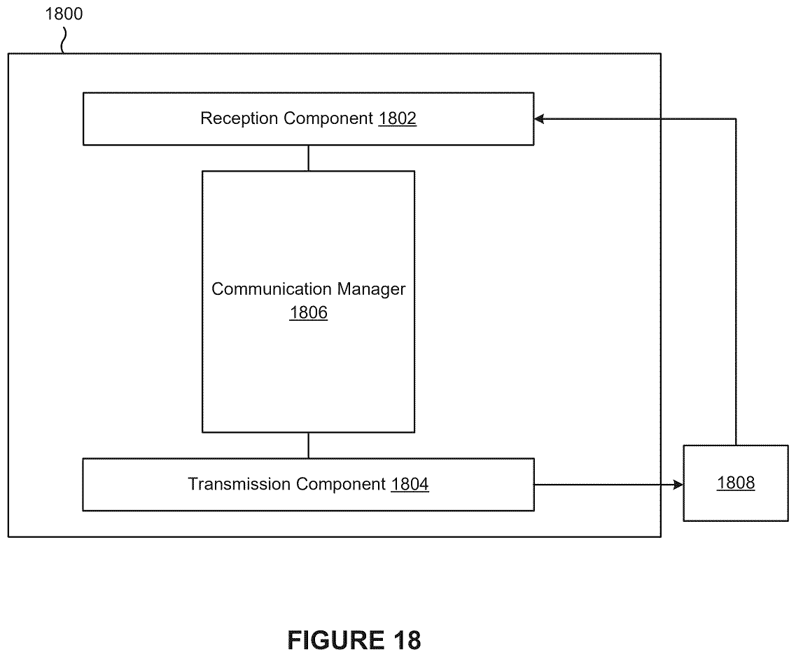

In some aspects, the network node 110 includes means for transmitting one or more beam sweeping signals via one or more respective network beams; means for receiving a plurality of first random access messages via respective UE beams associated with a network beam of the one or more respective network beams; and/or means for transmitting an indication of a UE beam of the respective UE beams. The means for the network node 110 to perform operations described herein may include, for example, one or more of communication manager 155, processing system 145, a radio, one or more RF chains, one or more transceivers, one or more antennas, one or more modems, a reception component (for example, reception component 1802 depicted and described in connection with FIG. 18), and/or a transmission component (for example, transmission component 1804 depicted and described in connection with FIG. 18), among other examples.

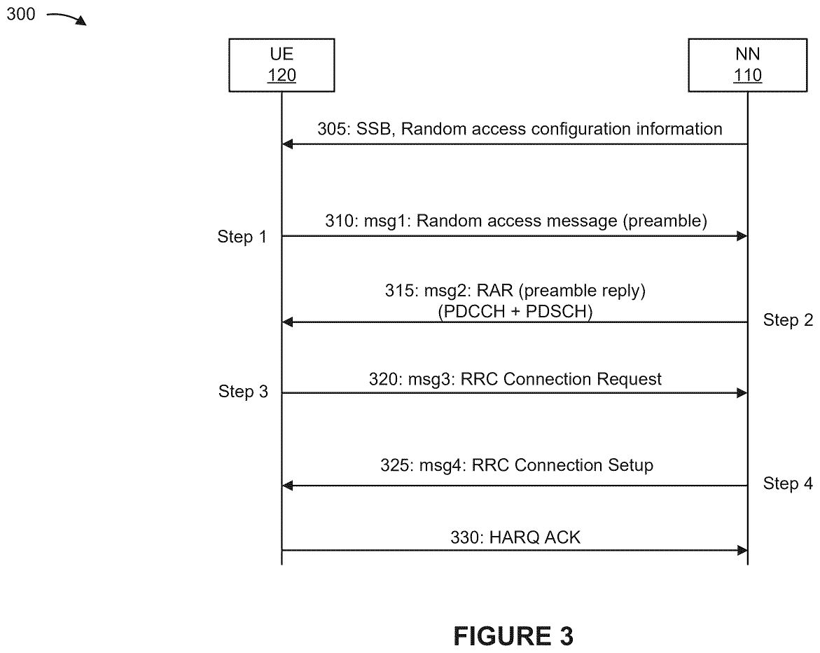

FIG. 3 is a diagram illustrating an example of a four-step random access procedure in accordance with the present disclosure. As shown in FIG. 3, a network node 110 and a UE 120 may communicate with one another to perform the four-step random access procedure.

In a first operation 305, the network node 110 may transmit, and the UE 120 may receive, one or more SSBs and random access configuration information. In some examples, the random access configuration information may be transmitted in and/or indicated by system information (for example, in one or more SIBs) and/or an SSB, such as for contention-based random access. Additionally or alternatively, the random access configuration information may be transmitted in a RRC message and/or a physical downlink control channel (PDCCH) order message that triggers a RACH procedure, such as for contention-free random access. The random access configuration information may include one or more parameters to be used in the random access procedure, such as one or more parameters for transmitting a random access message (RAM) and/or one or more parameters for receiving a random access response (RAR).

In a second operation 310, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

In a third operation 315, the network node 110 may transmit an RAR as a reply to the preamble. The message that includes the RAR may be referred to as message 2, msg2, MSG2, or a second message in a four-step random access procedure. In some examples, the RAR may indicate the detected random access preamble identifier (for example, received from the UE 120 in msg1). Additionally or alternatively, the RAR may indicate a resource allocation to be used by the UE 120 to transmit message 3 (msg3).

In some examples, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC protocol data unit (PDU) of the PDSCH communication.

In a fourth operation 320, the UE 120 may transmit an RRC connection request message. The RRC connection request message may be referred to as message 3, msg3, MSG3, or a third message of a four-step random access procedure. In some examples, the RRC connection request may include a UE identifier, UCI, and/or a PUSCH communication (for example, an RRC connection request).

In a fifth operation 325, the network node 110 may transmit an RRC connection setup message. The RRC connection setup message may be referred to as message 4, msg4, MSG4, or a fourth message of a four-step random access procedure. In some examples, the RRC connection setup message may include the detected UE identifier, a timing advance value, and/or contention resolution information. In a sixth operation 330, if the UE 120 successfully receives the RRC connection setup message, the UE 120 may transmit a HARQ ACK.

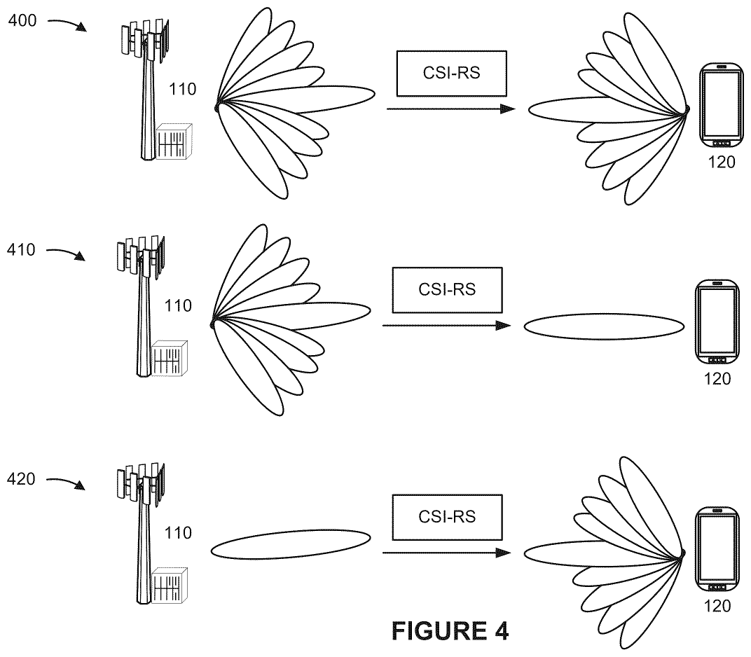

FIG. 4 is a diagram illustrating examples 400, 410, and 420 of CSI-RS beam management procedures in accordance with the present disclosure. As shown in FIG. 4, examples 400, 410, and 420 include a UE 120 in communication with a network node 110 in a wireless network (for example, wireless communication network 100). However, the devices shown in FIG. 4 are provided as examples, and the wireless network may support communication and beam management between other devices (for example, between a UE 120 and a network node 110 or transmit receive point (TRP), between a mobile termination node and a control node, between an integrated access and backhaul (IAB) child node and an IAB parent node, and/or between a scheduled node and a scheduling node). In some examples, the UE 120 and the network node 110 may be in a connected state (for example, an RRC connected state).

As shown in FIG. 4, example 400 may include a network node 110 (for example, one or more network node devices such as an RU, a DU, and/or a CU, among other examples) and a UE 120 communicating to perform beam management using CSI-RSs. Example 400 depicts a first beam management procedure (for example, P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (for example, using RRC signaling), semi-persistent (for example, using MAC-CE signaling), and/or aperiodic (for example, using DCI).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (for example, with repetitions) each CSI-RS at multiple times within the same reference signal (RS) resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use SSBs for beam management in a similar manner as described above.

As shown in FIG. 4, example 410 may include a network node 110 and a UE 120 communicating to perform beam management using CSI-RSs. Example 410 depicts a second beam management procedure (for example, P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (for example, using DCI). The second beam management procedure may include the network node 110 performing beam sweeping over one or more transmit beams. The one or more transmit beams may be a subset of all transmit beams associated with the network node 110 (for example, determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (for example, a same) receive beam (for example, determined based at least in part on measurements performed in connection with the first beam management procedure). The second beam management procedure may enable the network node 110 to select a best transmit beam based at least in part on measurements of the CSI-RSs (for example, measured by the UE 120 using the single receive beam) reported by the UE 120.

As shown in FIG. 4, example 420 depicts a third beam management procedure (for example, P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (for example, using DCI). The third beam management process may include the network node 110 transmitting the one or more CSI-RSs using a single transmit beam (for example, determined based at least in part on measurements reported by the UE 120 in connection with the first beam management procedure and/or the second beam management procedure). To enable the UE 120 to perform receive beam sweeping, the network node may use a transmit beam to transmit (for example, with repetitions) CSI-RS at multiple times within the same RS resource set so that UE 120 can sweep through one or more receive beams in multiple transmission instances. The one or more receive beams may be a subset of all receive beams associated with the UE 120 (for example, determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (for example, of the CSI-RS of the transmit beam using the one or more receive beams).

Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

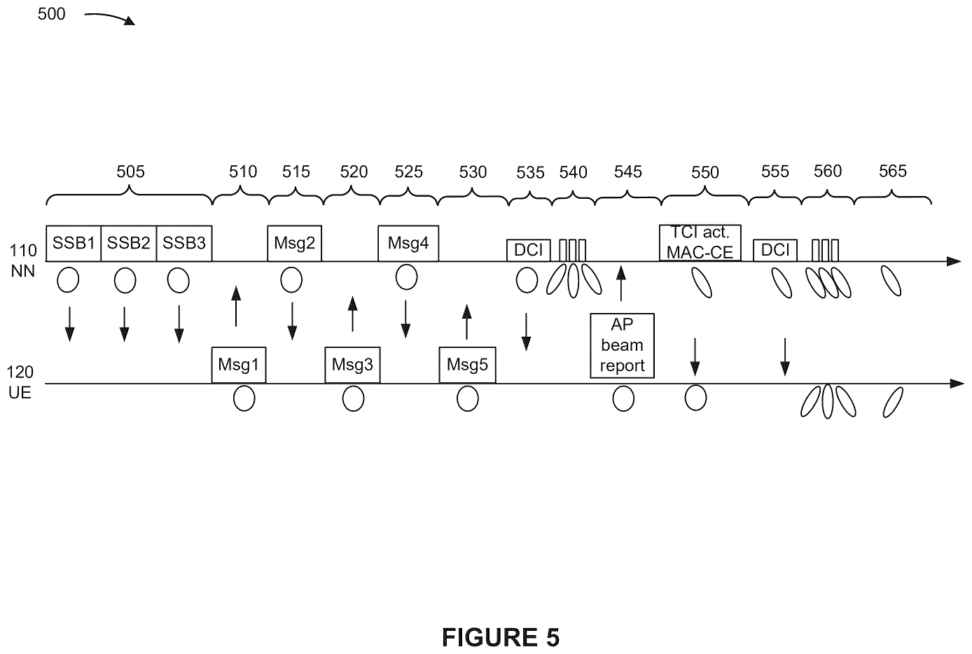

FIG. 5 is a diagram illustrating an example 500 of aperiodic P2 and/or P3 beam refinement for idle UE initial access in multi-beam operation in accordance with the present disclosure. As shown in FIG. 5, a network node 110 and a UE 120 may communicate with one another.

In a first operation 505, the network node 110 may transmit, and the UE 120 may receive, a plurality of SSBs via respective network wide beams. In a second operation 510, the UE 120 may transmit, and the network node 110 may receive, a msg1 via a UE wide beam associated with a selected network wide beam. In a third operation 515, the network node 110 may transmit, and the UE 120 may receive, a msg2 (for example, an RAR) via the selected network wide beam. In a fourth operation 520, the UE 120 may transmit, and the network node 110 may receive, a msg3 (for example, an RRC complete request) via the UE wide beam. In a fifth operation 525, the network node 110 may transmit, and the UE 120 may receive, a msg4 (for example, an RRC setup message) via the selected network wide beam. In a sixth operation 530, the UE 120 may transmit, and the network node 110 may receive, via the UE wide beam, an RRC setup complete message, which may be referred to as a message 5, msg5, MSG5, or a fifth message of a four-step random access procedure.

In a seventh operation 535, the network node 110 may transmit, and the UE 120 may receive, via the selected network wide beam, DCI that schedules beam sweeping signals and/or an aperiodic P2 beam report for network beam refinement. In an eighth operation 540, the network node 110 may transmit, and the UE 120 may receive, the beam sweeping signals. The network node 110 may transmit the beam sweeping signals via respective network narrow beams associated with the selected network wide beam. In a ninth operation 545, the UE 120 may transmit, and the network node 110 may receive, the aperiodic P2 beam report via the UE wide beam. Operations 535-545 may be referred to as network beam refinement.

In a tenth operation 550, the network node 110 may transmit, and the UE 120 may receive, a TCI indication in accordance with the aperiodic P2 beam report. The network node 110 may transmit the TCI indication via a selected network narrow beam of the respective network narrow beams, and the UE 120 may receive the TCI indication via the UE wide beam. The TCI indication may include a TCI activation MAC-CE that activates or indicates a TCI for the selected network narrow beam. The tenth operation 550 may be referred to as TCI activation.

In an eleventh operation 555, the network node 110 may transmit, and the UE 120 may receive, via the selected network narrow beam, DCI that schedules beam sweeping signals. In a twelfth operation 560, the network node 110 may transmit, and the UE 120 may receive, beam sweeping signals. The network node 110 may transmit the beam sweeping signals via the selected network narrow beam, and the UE 120 may receive the beam sweeping signals via respective UE narrow beams associated with the UE wide beam. In a thirteenth operation 565, the network node 110 and the UE 120 may exchange messages using the selected network narrow beam and a selected UE narrow beam of the respective UE narrow beams. The selected network narrow beam and the selected UE narrow beam may be referred to as refined beams. Operations 555-565 may be referred to as UE beam refinement, such as aperiodic P3 beam refinement for the indicated TCI to refine the UE wide beam (for example, a corresponding UE receive beam).

The aperiodic P2 and/or P3 beam refinement, which may include the network beam refinement, the TCI activation, and the UE beam refinement, may have excessive delays. For example, operations 505-530 may occur before the aperiodic P2 and/or P3 beam refinement. Furthermore, for an SCS of 15 kHz, the network beam refinement may be 1 slot, the TCI activation may be 3 slots, and the UE beam refinement may be 1 slot, resulting in a total of 5 slots for the aperiodic P2 and/or P3 beam refinement. For an SCS of 120 kHz, the network beam refinement may be 3 slots, the TCI activation may be 24 slots, and the UE beam refinement may be 3 slots, resulting in a total of 30 slots for the aperiodic P2 and/or P3 beam refinement.

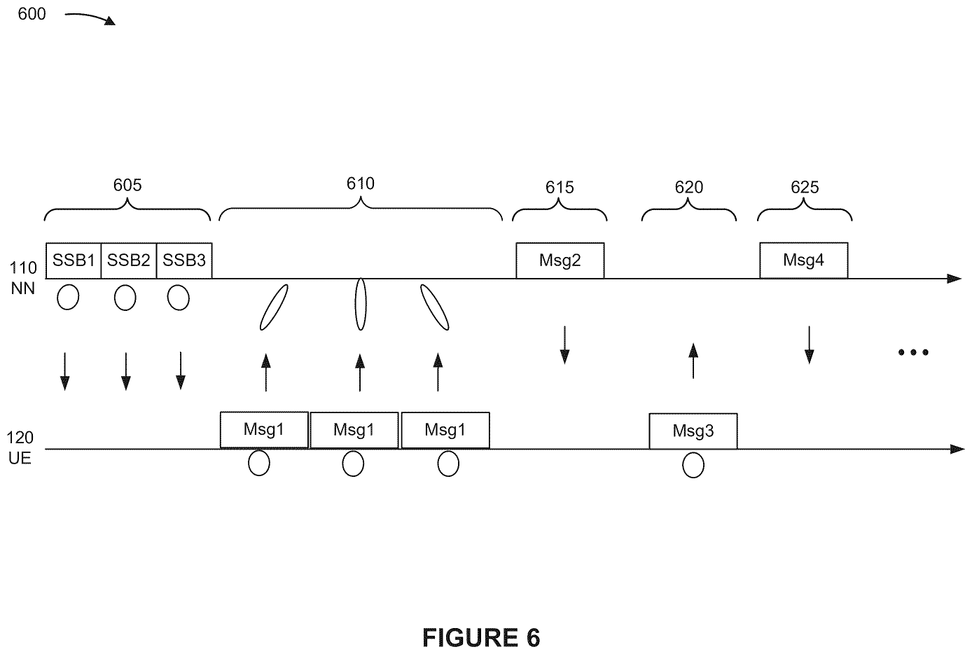

FIG. 6 is a diagram illustrating an example 600 of network node beam refinement via msg1 repetition in accordance with the present disclosure.

In a first operation 605, the network node 110 may transmit, and the UE 120 may receive, a plurality of SSBs via respective network wide beams. In a second operation 610, the UE 120 may transmit, and the network node 110 may receive, msg1s. The UE 120 may transmit the msg1s via a UE wide beam associated with a selected network wide beam of the respective network wide beams, and the network node 110 may receive the beam sweeping signals via respective network narrow beams associated with the selected network wide beam.

The second operation 610 may be referred to as msg1 repetition. For example, msg1 repetition may involve sequence repetition within a preamble format and/or preamble repetition. In some examples, the network node 110 may select a network narrow beam of the respective network narrow beams. For example, the network node 110 may refine the selected network wide beam by performing a beam sweep over the respective network narrow beams within the selected network wide beam (for example, an SSB receive beam). Thus, in some examples, the selected network narrow beam may be referred to as a refined network narrow beam.

The network node 110 may use the selected network narrow beam for subsequent downlink transmissions and/or uplink receptions. For example, in a third operation 615, the network node 110 may transmit, and the UE 120 may receive, a msg2 (for example, an RAR). The network node 110 may transmit the msg2 via the selected network narrow beam. In a fourth operation 620, the UE 120 may transmit, and the network node 110 may receive, a msg3 (for example, an RRC setup request). The UE 120 may transmit the msg3 via the UE wide beam. In a fifth operation 625, the network node 110 may transmit, and the UE 120 may receive, a msg4 (for example, an RRC setup message). The network node 110 may transmit the msg4 via the selected network narrow beam.

The network node beam refinement via msg1 repetition may enable network beam refinement during initial access, thereby helping to reduce a quantity of required repetitions and providing similar coverage as that in example 500. However, example 600 may nonetheless have excessive delays caused by UE beam refinement. For example, after the fifth operation 625, the network node 110 and the UE 120 may perform operations similar to operations 555-565, which may contribute to the excessive delays.

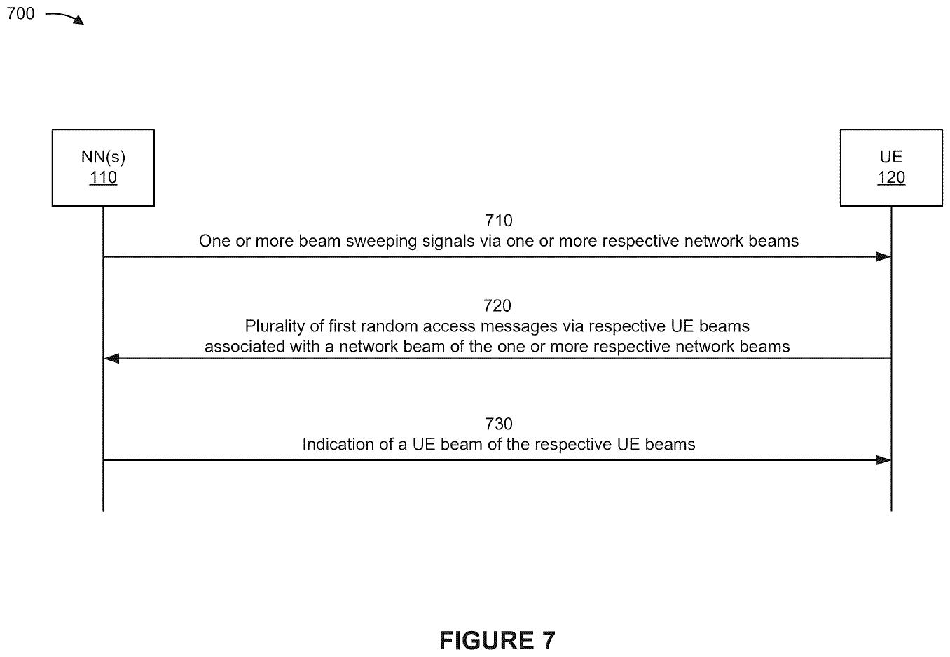

FIG. 7 is a diagram illustrating an example 700 associated with signaling for beam selection with random access in accordance with the present disclosure. As shown in FIG. 7, a network node 110 and a UE 120 may communicate with one another.

In a first operation 710, the network node 110 may transmit, and the UE 120 may receive, one or more beam sweeping signals via one or more respective network beams. For example, the beam sweeping signals may be SSB signals, and the one or more respective network beams may be network wide beams. The UE 120 may receive the one or more beam sweeping signals via one or more respective UE wide beams (for example, respective initial receive beams), measure the beam sweeping signals, and select a UE wide beam corresponding to a strongest beam sweeping signal (for example, SSB X).

In a second operation 720, the UE 120 may transmit, and the network node 110 may receive, a plurality of first random access messages via respective UE beams associated with a network beam of the one or more respective network beams. For example, the first random access messages may be msg1s, the UE beams may be UE narrow beams, and the network beam may be the network wide beam that carried the strongest beam sweeping signal. The respective UE beams may be associated with the network beam in that the respective UE beams may correspond to the network beam. For example, the UE beams may be UE narrow beams (for example, narrow transmit beams) within the UE wide beam that received the strongest beam sweeping signal transmitted by the network beam. Thus, for example, the UE 120 may sweep across the UE beams within the UE wide beam corresponding to the strongest beam sweeping signal by transmitting multiple msg1s in response to SSB X.

In a third operation 730, the network node 110 may transmit, and the UE 120 may receive, an indication of a UE beam of the respective UE beams. The network node 110 may receive the first random access messages via the network beam, measure the first random access messages, and select the UE beam corresponding to a strongest first random access message. In some examples, the UE 120 may receive the indication via the UE wide beam corresponding to the strongest beam sweeping signal. The UE beam may be referred to as a refined narrow beam.

In some aspects, the indication may be a second random access message. For example, the second random access message may be a msg2. Thus, in some examples, the network node 110 may indicate the UE beam corresponding to the strongest beam sweeping signal in the msg2.

In some aspects, the network node 110 and the UE 120 may communicate (for example, transmit and/or receive) one or more signals via the UE beam. For example, after the UE 120 receives the indication of the UE beam, the UE 120 may transmit, and the network node 110 may receive, a msg3 via the UE beam. Moreover, the network node 110 may transmit, and the UE 120 may receive, a msg4 via the UE beam.

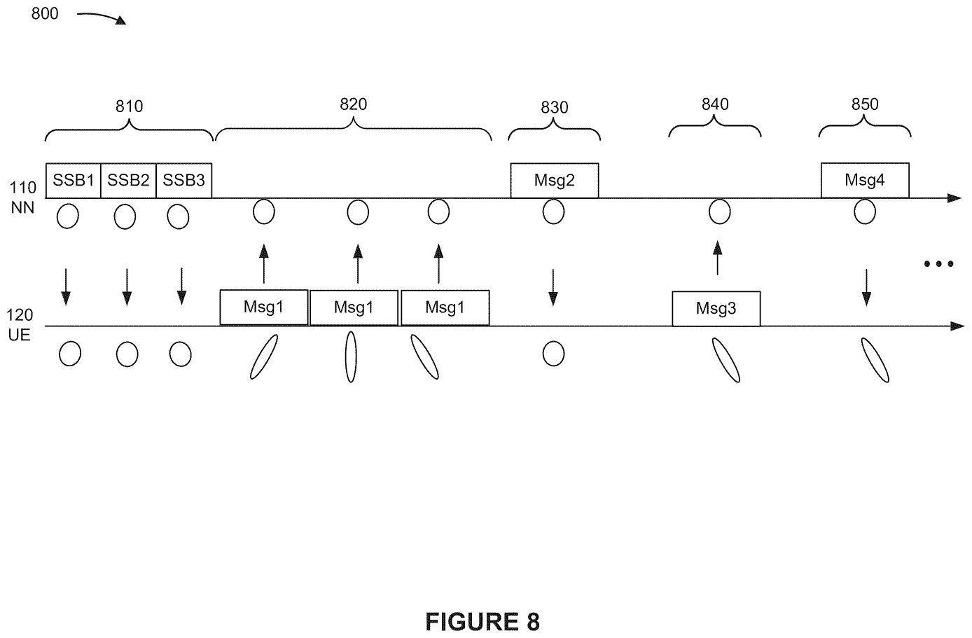

FIG. 8 is a diagram illustrating an example 800 associated with UE beam refinement via msg1 repetition in accordance with the present disclosure. As shown in FIG. 8, a network node 110 and a UE 120 may communicate with one another.

In a first operation 810, the network node 110 may transmit, and the UE 120 may receive, beam sweeping signals SSB1, SSB2, and SSB3 via respective network beams. The UE 120 may receive SSB1, SSB2, and SSB3 via respective UE wide beams. In this example, the UE 120 may identify SSB2 as the strongest SSB and select an initial UE wide beam corresponding to SSB2.

In a second operation 820, the UE 120 may transmit, and the network node 110 may receive, a plurality of msg1s via respective UE narrow beams within the initial UE wide beam. For example, as shown, the UE 120 may perform a UE narrow beam sweep over three UE narrow beams.

In a third operation 830, the network node 110 may transmit, and the UE 120 may receive, a msg2 that indicates a UE refined beam corresponding to the strongest msg1 as measured by the network node 110. For example, the msg2 may include an indication to use a third UE narrow beam of the three UE narrow beams. The network node 110 may transmit the msg2 via the network beam, and the UE 120 may receive the msg2 via the initial UE wide beam.

In a fourth operation 840, the UE 120 may transmit, and the network node 110 may receive, a msg3 via the UE refined beam. In a fifth operation 850, the network node 110 may transmit, and the UE 120 may receive, a msg4 via the UE refined beam. The network node 110 and the UE 120 may thereafter continue to communicate via the UE refined beam.

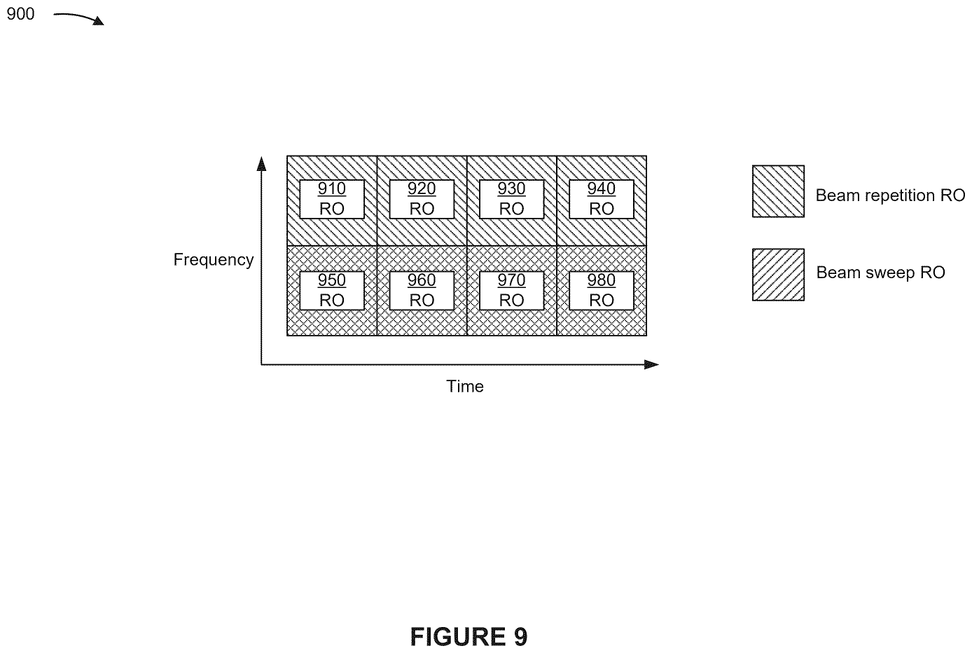

FIG. 9 is a diagram illustrating an example 900 associated with RACH occasions (ROs) in accordance with the present disclosure.

In some aspects, network node 110 may transmit, and the UE 120 may receive, an indication to transmit the plurality of first random access messages via the respective UE beams. In some examples, the network node 110 may indicate whether the UE 120 is to perform a beam sweep (for example, across respective UE beams) or beam repetition (for example, over the same UE beam) of multiple msg1 transmissions. For example, an indication to perform the beam sweep may be the indication to transmit the plurality of first random access messages via the respective UE beams. In some examples, the indication may be carried in remaining minimum system information (RMSI) (for example, before the network node 110 transmits the beam sweeping signal(s)).

In some aspects, the indication may indicate one or more of a first random access message transmission quantity threshold or a plurality of ROs associated with the plurality of first random access messages. The first random access message transmission quantity threshold may be a maximum quantity of first random access messages that can be transmitted on a given UE beam during the beam sweep. The first random access message transmission quantity threshold may be a first random access message transmission quantity threshold for beam sweeping, and may be different (for example, less) than a first random access message transmission quantity threshold for beam repetition.

An RO may be associated with a first random access message in that the RO may be a time and frequency resource in which the network node 110 is available for reception of the first random access message. For example, the UE 120 may receive a plurality of SSBs associated with respective network beams, select a particular SSB, and use a mapping of SSBs to ROs to transmit the first random access message on an RO in accordance with the selected SSB. The network node 110 may receive the first random access message on the RO and use the mapping of SSBs to ROs to identify the network beam associated with the selected SSB. The plurality of ROs may be the ROs that the UE 120 is to use for beam sweeping, and may be a subset of ROs for beam repetition for each SSB.

As shown in FIG. 9, ROs 910-980 are associated with SSB X. ROs 910-980 may be used for beam repetition, and ROs 950-980 may be used for beam sweeping. In some examples, the maximum quantity of ROs that can be used for beam repetition may be eight, and the maximum quantity of ROs that can be used for beam sweeping may be four. In example 900, the network node 110 may indicate which four ROs (for example, ROs 950-980) can be used for beam sweeping out of the eight ROs that can be used for beam repetition (for example, ROs 910-980).

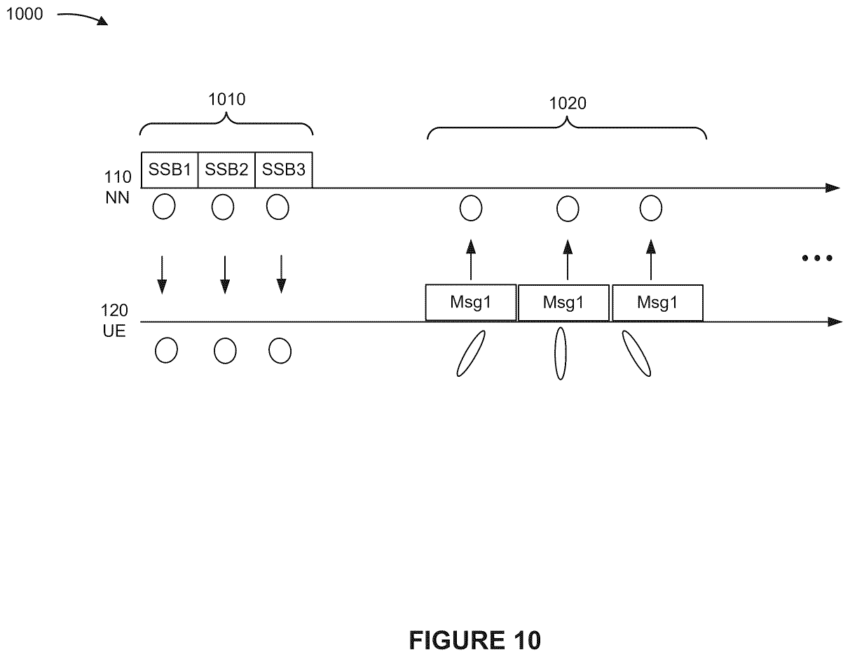

FIG. 10 is a diagram illustrating an example 1000 associated with transmit power in accordance with the present disclosure. As shown in FIG. 10, a network node 110 and a UE 120 may communicate with one another.

In a first operation 1010, the network node 110 may transmit, and the UE 120 may receive, beam sweeping signals SSB1, SSB2, and SSB3 via respective network beams. The UE 120 may receive SSB1, SSB2, and SSB3 via respective UE wide beams. In this example, the UE 120 may identify SSB2 as the strongest SSB and select an initial UE wide beam corresponding to SSB2.

In a second operation 1020, the UE 120 may transmit, and the network node 110 may receive, a plurality of msg1s via respective UE narrow beams within the initial UE wide beam. For example, as shown, the UE 120 may perform a UE narrow beam sweep over three UE narrow beams.

In some aspects, a transmit power of the plurality of first random access messages may be in accordance with one or more transmit power control (TPC) parameters associated with first random access message beam sweeping. The one or more TPC parameters may be associated with first random access message beam sweeping in that the TPC parameter(s) may be dedicated for first random access message beam sweeping. For example, one or more other TPC parameter(s) may be dedicated for first random access message beam repetition (for example, one or more of the TPC parameters for beam sweeping may be different than one or more of the other TPC parameters for beam repetition). In some examples, the TPC parameter(s) may determine the transmit power (for example, the uplink transmit power) for beam sweeping across the first random access message transmissions. For example, the uplink transmit power may equal min(Pmax, P0+alpha*pathloss+delta), where the one or more TPC parameters include one or more of Pmax, P0, alpha, pathloss, and delta. Pmax is a maximum uplink transmit power, P0 is a target receive power at the network node 110, alpha is a compensation factor for pathloss (for example, if alpha=0, then the UE 120 may not compensate for pathloss, and if alpha=1, then the UE 120 may fully compensate for the pathloss), pathloss may be measured or estimated using the SSBs received by the UE wide beams (for example, SSB2), and delta is a predefined or preconfigured value that iteratively boosts the uplink transmit power of each subsequent retransmission. In some examples, the TPC parameters may boost the uplink RSRPs of all of the UE narrow beams. For example, the TPC parameters may be common across all of the UE narrow beams (for example, the TPC parameters may be non-beam-specific).

In some aspects, the network node 110 may transmit, and the UE 120 may receive, an indication of one or more absolute values of the one or more TPC parameters. For example, the network node 110 may indicate (for example, explicitly indicate) values for the TPC parameters for beam sweeping. The one or more absolute values of the one or more TPC parameters may be carried in a RACH-ConfigCommon parameter in the RMSI. In some examples, the network node 110 may indicate absolute values of P0 and alpha.

In some aspects, the network node 110 may transmit, and the UE 120 may receive, an indication of one or more differential values of the one or more TPC parameters. For example, the network node 110 may indicate an offset between values of the TPC parameters for beam sweeping and values of the TPC parameters for beam repetition. The one or more differential values of the one or more TPC parameters may be carried in the RACH-ConfigCommon parameter in the RMSI.

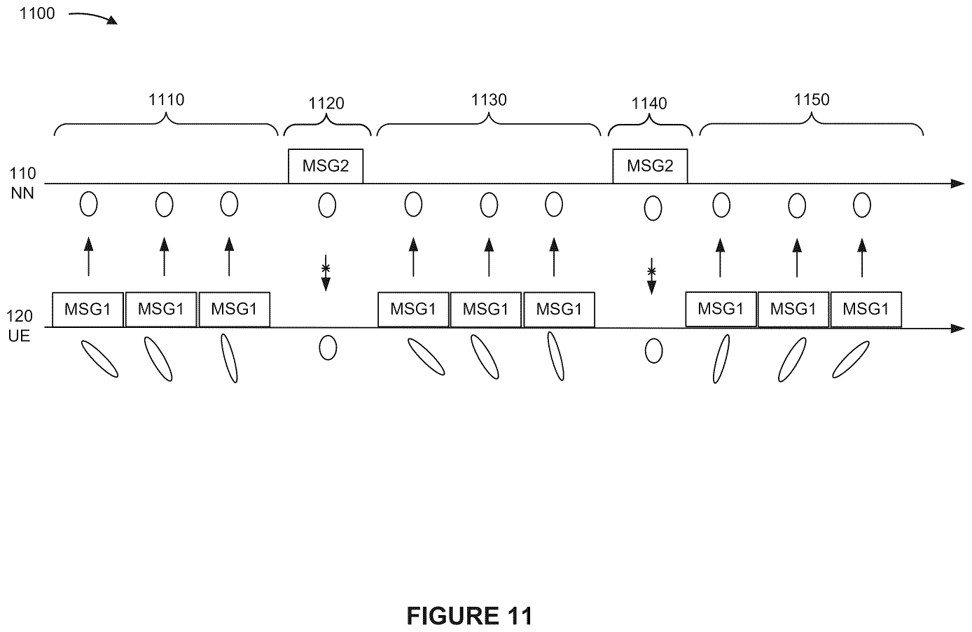

FIG. 11 is a diagram illustrating an example 1100 associated with random access failure in accordance with the present disclosure. As shown in FIG. 11, a network node 110 and a UE 120 may communicate with one another.

In a first operation 1110, the UE 120 may transmit, and the network node 110 may receive, a plurality of msg1s via respective UE narrow beams within an initial UE wide beam (for example, a UE wide beam for SSB X). For example, as shown, the UE 120 may perform a UE narrow beam sweep over three UE narrow beams.

In a second operation 1120, a random access failure may occur. The random access failure may include the network node 110 not receiving a msg1 or the network node 110 not transmitting a msg2 (for example, an RAR) in response to a msg1, among other examples. As shown in example 1100, the UE 120 may not receive a msg2 that the network node 110 transmits in response to receiving the msg1. In some examples, the UE 120 may retransmit the plurality of msg1s in response to the random access failure.

In some aspects, a transmit power of the plurality of first random access messages (for example, the msg1s) may be associated with the random access failure. The transmit power may be associated with the random access failure in that the UE 120 may set the transmit power in accordance with the occurrence of the random access failure. For example, the UE 120 may determine the uplink power (for example, the uplink transmit power) for beam sweeping across msg1 retransmission.

In some aspects, the transmit power of the plurality of first random access messages may be greater than a transmit power of a plurality of first random access messages that were previously transmitted. For example, the UE 120 may use an uplink transmit power in accordance with the power control equation with a power boost that is calculated using the delta value multiplied by a retransmission number of the msg1s. The UE 120 may boost the uplink transmit power regardless of which beams are swept.

In some aspects, the transmit power of the plurality of first random access messages may be equal to a transmit power of a plurality of first random access messages that were previously transmitted. For example, the UE 120 may use an uplink transmit power in accordance with the power control equation without a power boost. The UE 120 may use the uplink transmit power without a boost regardless of which beams are swept.

In some aspects, the transmit power of the plurality of first random access messages may be greater than a transmit power of a plurality of first random access messages that were previously transmitted via the respective UE beams, or the transmit power of the plurality of first random access messages may be equal to a transmit power of a plurality of first random access messages that were previously transmitted via other respective UE beams that are different than the respective UE beams. For example, whether or not to boost the uplink transmit power for beam sweeping across msg1 retransmissions may depend on which beams are swept. For example, in a third operation 1130, the UE 120 may retransmit, and the network node 110 may receive, the plurality of msg1s via the same respective UE narrow beams as the msg1s transmitted in the first operation 1110. Because the UE 120 performs the same beam sweep across the msg1 retransmission, the uplink transmit power may be boosted by an uplink transmit power in accordance with the power control equation with a power boost that is calculated using the delta value multiplied by a retransmission number of the msg1s. In a fourth operation 1140, another random access failure may occur, and in a fifth operation 1150, the UE 120 may retransmit, and the network node 110 may receive, the plurality of msg1s via respective UE narrow beams that are different than those that were used to transmit the msg1s in the first operation 1110 and the third operation 1130. The different UE narrow beams may be within the initial UE wide beam. Because the UE 120 performs a different beam sweep across the msg1 retransmission, the uplink transmit power may be in accordance with the power control equation without a power boost.

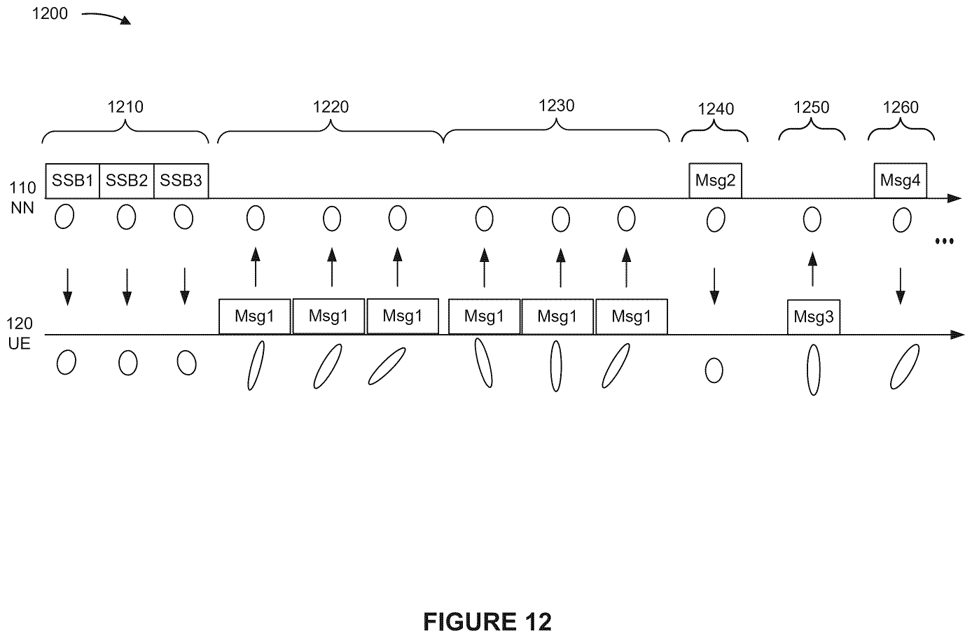

FIG. 12 is a diagram illustrating an example 1200 associated with RO allocation in accordance with the present disclosure. As shown in FIG. 12, a network node 110 and a UE 120 may communicate with one another.

In a first operation 1210, the network node 110 may transmit, and the UE 120 may receive, beam sweeping signals SSB1, SSB2, and SSB3 via respective network beams. The UE 120 may receive SSB1, SSB2, and SSB3 via respective UE wide beams. In some examples, ROs for each SSB may be split into two subsets for downlink beam selection and uplink beam selection, respectively. For example, eight ROs for each SSB may be split into two subsets (for example, first through fourth ROs for the downlink UE beam selection and fifth through eighth ROs for the uplink UE beam selection).

In a second operation 1220, the UE 120 may transmit, and the network node 110 may receive, a plurality of first random access messages in one or more first ROs associated with downlink UE beam selection. The first ROs may be associated with downlink UE beam selection in that the first ROs may be allocated and/or configured for downlink UE beam selection. The UE 120 may transmit the first plurality of msg1s in first, second, and third ROs associated with SSB 1 for downlink beam selection. In some examples, the UE 120 may select the ROs associated with SSB 1 for downlink beam selection in which to transmit the msg1s.

In a third operation 1230, the UE 120 may transmit, and the network node 110 may receive, another plurality of first random access messages via other respective UE beams associated with another network beam of the one or more respective network beams in one or more second ROs associated with uplink UE beam selection. The second ROs may be associated with uplink UE beam selection in that the second ROs may be allocated and/or configured for uplink UE beam selection. The UE 120 may transmit the first plurality of msg1s in fifth, sixth, and seventh ROs associated with SSB 1 for uplink beam selection. In some examples, the UE 120 may select the ROs associated with SSB 2 for uplink beam selection in which to transmit. Thus, for example, if the UE 120 selects SSB X for a highest-quality downlink UE beam and SSB Y as a highest-quality uplink UE beam, then the UE 120 may indicate a selection of the downlink and uplink beams by transmitting a msg1 on the first ROs (associated with SSB X) and the second ROs (associated with SSB Y).

In a fourth operation 1240, the network node 110 may transmit, and the UE 120 may receive, an indication of a downlink UE beam of the respective UE beams and/or an indication of an uplink UE beam of the other respective UE beams. For example, the downlink UE beam (for example, a downlink refined UE beam) may be selected for receiving downlink transmissions, and the uplink UE beam (for example, an uplink refined UE beam) may be selected for transmitting uplink transmissions. Thus, the network node 110 may indicate which beams the UE 120 is to use for subsequent downlink and/or uplink messages. For example, the network node 110 may accept or reject a candidate downlink UE beam and/or a candidate uplink UE beam proposed by the UE 120. In some examples, the indication(s) may be carried in a msg2. For example, the network node 110 may transmit the msg2 via the network beam, and the UE 120 may receive the msg2 via the initial UE wide beam.

In a fifth operation 1250, the UE 120 may transmit, and the network node 110 may receive, a msg3 via the uplink UE refined beam. In a sixth operation 1260, the network node 110 may transmit, and the UE 120 may receive, a msg4 via the downlink UE refined beam. The network node 110 and the UE 120 may thereafter continue to communicate via the UE refined beam.

In some aspects, a first network beam on which a first beam sweeping signal (for example, SSB1) is transmitted may be different than a second network beam on which a second beam sweeping signal (for example, SSB2) is transmitted. For example, the first ROs and the second ROs may be associated with different SSBs (for example, SSB 1 and SSB 2 may be different SSBs, and the first selected UE narrow beam may be different than the second selected UE narrow beam). In other examples, the first ROs and the second ROs may be associated with the same SSB (for example, SSB 1 and SSB 2 may be the same SSB, and the first selected UE narrow beam may be the same as the second selected UE narrow beam).

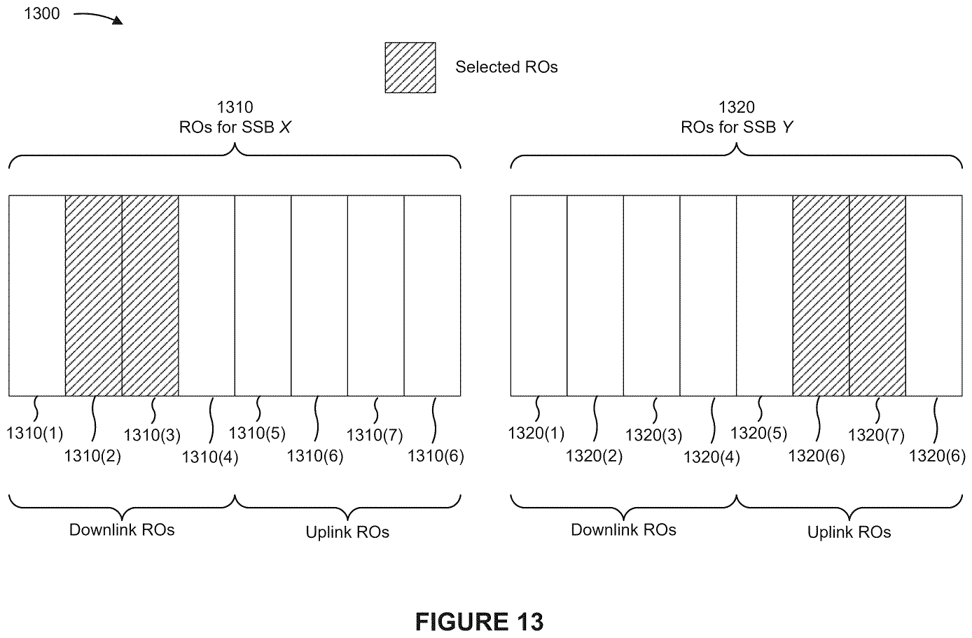

FIG. 13 is a diagram illustrating an example 1300 associated with RO indexes in accordance with the present disclosure.

In some aspects, one or more indexes of the one or more first ROs (associated with downlink UE beam selection) may be associated with one or more indexes of the one or more second ROs (associated with uplink UE beam selection). An index of a first RO may be associated with an index of a second RO in that the index of the first RO may be an nth index within a set of indexes of ROs associated with downlink UE beam selection, and the index of the second RO may be an nth index within a set of indexes of ROs associated with uplink UE beam selection. For example, if the UE 120 selects SSB X for a highest-quality downlink UE beam and SSB Y as a highest-quality uplink UE beam, then the UE 120 may transmit a msg1 on an nth downlink RO associated with the SSB X and another msg1 on an nth uplink RO associated with the SSB Y. For example, the UE 120 may use the same RO index number (and/or the same preamble) for downlink and uplink beam selection.

Example 1300 shows ROs 1310(1)-1310(8) (collectively, ROs 1310) and ROs 1320(1)-1320(8) (collectively, ROs 1320). ROs 1310(1)-1310(4) are downlink ROs, ROs 1310(5)-1310(8) are uplink ROs, ROs 1320(1)-1320(4) are downlink ROs, and ROs 1320(5)-1320(8) are uplink ROs. As shown, the UE 120 may select ROs 1310(2) and 1310(3) (for example, the first ROs), which are the second and third ROs in the downlink ROs of the ROs 1310. Similarly, the UE 120 may select ROs 1320(6) and 1320(7) (for example, the second ROs), which are the second and third ROs in the uplink ROs of the ROs 1320. In this manner, the indexes of the first ROs and the second ROs may be associated with each other.

In some aspects, a random access radio network temporary identifier (RA-RNTI) of a downlink communication that schedules a second random access message carrying the indication of the downlink UE beam and the indication of the uplink UE beam may be associated with the one or more first ROs or the one or more second ROs. For example, the RA-RNTI may be for a PDCCH that schedules a msg2. In some examples, the RA-RNTI may be associated with the first RO(s) or the second RO(s) in that the RA-RNTI may be determined by the first RO(s). In some examples, the RA-RNTI may be associated with the first RO(s) or the second RO(s) in that the RA-RNTI may be determined by the second RO(s).

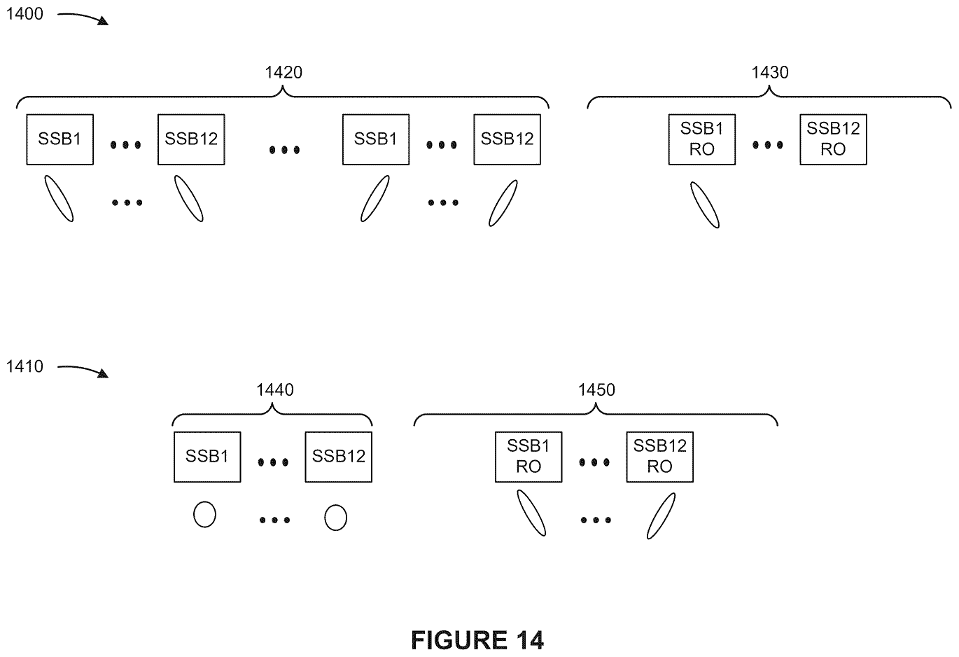

FIG. 14 is a diagram illustrating examples 1400 and 1410 associated with UE beam refinement for primary secondary cell (PScell) activation by a primary cell (PCell) in accordance with the present disclosure. Examples 1400 and 1410 may relate to identification of a highest-quality UE narrow beam during initial access for PSCell activation by the PCell. In both examples 1400 and 1410, the UE 120 may be configured with an SSB period of 20 ms and a RACH configuration period of 40 ms. An SSB period may be a length of time for which the network node 110 transmits a burst of SSBs, and a RACH configuration period may be a length of time during which the UE 120 may transmit one or more uplink random access communications in one or more ROs corresponding to one or more of the SSBs. Each example 1400 and 1410 may involve eight candidate UE narrow beams.

With reference to example 1400, in a first operation 1420, the UE 120 may sweep the eight UE narrow beams across the eight SSB bursts. The UE 120 may identify a highest-quality UE narrow beam and, in a second operation 1430, indicate the highest-quality SSB by transmitting a msg1 on an RO corresponding to the highest-quality SSB during a RACH configuration period. As a result, in example 1400, the lowest beam pair determination and indication latency is 8*20 ms+40 ms=200 ms.

The plurality of first random access messages being transmitted via respective UE beams associated with a network beam of the one or more respective network beams may help to reduce delays associated with UE beam refinement by enabling early UE beam refinement during random access. For instance, example 1410 relates to UE beam refinement for PScell activation by a PCell via msg1 repetition. In a third operation 1440, the UE 120 may measure SSBs within an SSB burst using a wide UE beam. The UE 120 may identify a highest-quality SSB and, in a fourth operation 1450, refine the UE wide beam by sweeping the eight UE narrow beams within the UE wide beam across multiple msg1 transmissions that indicate the highest-quality SSB during a RACH configuration period. As a result, in example 1410, the lowest beam pair determination and indication latency is 20 ms+40 ms=60 ms. Thus, example 1410 may reduce latency by 200 ms−60 ms=140 ms.

The indication being a second random access message may help to further reduce latency. For example, the UE 120 may receive the indication in a msg2 that follows the msg1(s).

The indication indicating one or more of a first random access message transmission quantity threshold or a plurality of ROs associated with the plurality of first random access messages may help to reduce an uplink RSRP difference across the beam sweep by limiting an ADC input range, which may help to reduce hardware complexity or lower quantization error, among other examples.

A transmit power of the plurality of first random access messages being in accordance with one or more TPC parameters associated with first random access message beam sweeping may help to boost uplink RSRPs of all of the UE uplink beams for a beam sweep. Unlike in beam repetition, UE uplink beams for a beam sweep may have no combining gain. For example, beam repetition across four msg1 transmissions may offer a 6 dB combining gain, whereas no such combining gain may be present for the beam sweep. Thus, the TPC parameter(s) may help to improve a transmission success rate for the first random access message beam sweeping.

The first plurality of first random access messages being transmitted in one or more first ROs associated with downlink UE beam selection, and the second plurality of first random access messages being transmitted in one or more second ROs associated with uplink UE beam selection, may help to improve downlink and/or uplink transmission success rates, such as in examples where a highest-quality downlink beam and a highest-quality uplink beam are different beams (for example, in examples involving MPE requirements that may constrain certain uplink transmission parameters).

The one or more indexes of the one or more first ROs being associated with one or more indexes of the one or more second ROs may enable the network node 110 to determine that a msg1 received on a first RO (for example, a downlink RO of SSB X) and a second RO (for example, an uplink RO of SSB Y) is associated with the same UE 120. For example, the network node 110 may use a rule that the one or more indexes of the one or more first ROs are associated with one or more indexes of the one or more second ROs to identify the appropriate ROs (and/or preambles) and thereby associate downlink beam selection and uplink beam selection with the same UE 120. For example, the network node 110 may determine that a msg1 received on the downlink ROs of SSB X and the uplink ROs of SSB Y is associated with the same UE 120 if the UE 120 uses the same RO index and/or preamble for the downlink and uplink beam selection.

FIG. 15 is a flowchart illustrating an example process 1500 performed, for example, at a UE or an apparatus of a UE that supports beam selection with random access in accordance with the present disclosure. Example process 1500 is an example where the apparatus or the UE (for example, UE 120) performs operations associated with beam selection with random access.

As shown in FIG. 15, in some aspects, process 1500 may include receiving one or more beam sweeping signals via one or more respective network beams (block 1510). For example, the UE (such as by using communication manager 150 or reception component 1702, depicted in FIG. 17) may receive one or more beam sweeping signals via one or more respective network beams, as described above.

As further shown in FIG. 15, in some aspects, process 1500 may include transmitting a plurality of first random access messages via respective UE beams associated with a network beam of the one or more respective network beams (block 1520). For example, the UE (such as by using communication manager 150 or transmission component 1704, depicted in FIG. 17) may transmit a plurality of first random access messages via respective UE beams associated with a network beam of the one or more respective network beams, as described above.

As further shown in FIG. 15, in some aspects, process 1500 may include receiving an indication of a UE beam of the respective UE beams (block 1530). For example, the UE (such as by using communication manager 150 or reception component 1702, depicted in FIG. 17) may receive an indication of a UE beam of the respective UE beams, as described above.

Process 1500 may include additional aspects, such as any single aspect or any combination of aspects described below or in connection with one or more other processes described elsewhere herein.

In a first additional aspect, the indication is a second random access message.

In a second additional aspect, alone or in combination with the first aspect, process 1500 includes communicating one or more signals via the UE beam.

In a third additional aspect, alone or in combination with one or more of the first and second aspects, process 1500 includes receiving an indication to transmit the plurality of first random access messages via the respective UE beams.

In a fourth additional aspect, alone or in combination with one or more of the first through third aspects, the indication indicates one or more of a first random access message transmission quantity threshold or a plurality of ROs associated with the plurality of first random access messages.

In a fifth additional aspect, alone or in combination with one or more of the first through fourth aspects, a transmit power of the plurality of first random access messages is in accordance with one or more TPC parameters associated with first random access message beam sweeping.

In a sixth additional aspect, alone or in combination with one or more of the first through fifth aspects, process 1500 includes receiving an indication of one or more absolute values of the one or more TPC parameters.

In a seventh additional aspect, alone or in combination with one or more of the first through sixth aspects, process 1500 includes receiving an indication of one or more differential values of the one or more TPC parameters.

In an eighth additional aspect, alone or in combination with one or more of the first through seventh aspects, a transmit power of the plurality of first random access messages is associated with a random access failure.

In a ninth additional aspect, alone or in combination with one or more of the first through eighth aspects, the transmit power of the plurality of first random access messages is greater than a transmit power of a plurality of first random access messages that were previously transmitted.

In a tenth additional aspect, alone or in combination with one or more of the first through ninth aspects, the transmit power of the plurality of first random access messages is equal to a transmit power of a plurality of first random access messages that were previously transmitted.

In an eleventh additional aspect, alone or in combination with one or more of the first through tenth aspects, the transmit power of the plurality of first random access messages is greater than a transmit power of a plurality of first random access messages that were previously transmitted via the respective UE beams, or the respective UE beams are first respective UE beams, and the transmit power of the plurality of first random access messages is equal to a transmit power of a plurality of first random access messages that were previously transmitted via second respective UE beams that are different than the first respective UE beams.

In a twelfth additional aspect, alone or in combination with one or more of the first through eleventh aspects, the plurality of first random access messages is a first plurality of first random access messages, the respective UE beams are first respective UE beams, the network beam is a first network beam, transmitting the first plurality of first random access messages comprises transmitting the first plurality of first random access messages in one or more first ROs associated with downlink UE beam selection, the UE beam is a downlink UE beam, and process 1500 includes transmitting a second plurality of first random access messages via second respective UE beams associated with a second network beam of the one or more respective network beams in one or more second ROs associated with uplink UE beam selection, and receiving an indication of an uplink UE beam of the second respective UE beams.

In a thirteenth additional aspect, alone or in combination with one or more of the first through twelfth aspects, the first network beam is different than the second network beam.

In a fourteenth additional aspect, alone or in combination with one or more of the first through thirteenth aspects, one or more indexes of the one or more first ROs are associated with one or more indexes of the one or more second ROs.

In a fifteenth additional aspect, alone or in combination with one or more of the first through fourteenth aspects, an RA-RNTI of a downlink communication that schedules a second random access message carrying the indication of the downlink UE beam and the indication of the uplink UE beam is associated with the one or more first ROs or the one or more second ROs.

Although FIG. 15 shows example blocks of process 1500, in some aspects, process 1500 may include additional blocks, fewer blocks, different blocks, or differently arranged blocks than those depicted in FIG. 15. Additionally or alternatively, two or more of the blocks of process 1500 may be performed in parallel.

FIG. 16 is a flowchart illustrating an example process 1600 performed, for example, at a network node or an apparatus of a network node that supports beam selection with random access in accordance with the present disclosure. Example process 1600 is an example where the apparatus or the network node (for example, network node 110) performs operations associated with beam selection with random access.

As shown in FIG. 16, in some aspects, process 1600 may include transmitting one or more beam sweeping signals via one or more respective network beams (block 1610). For example, the network node (such as by using communication manager 155 or transmission component 1804, depicted in FIG. 18) may transmit one or more beam sweeping signals via one or more respective network beams, as described above.

As further shown in FIG. 16, in some aspects, process 1600 may include receiving a plurality of first random access messages via respective UE beams associated with a network beam of the one or more respective network beams (block 1620). For example, the network node (such as by using communication manager 155 or reception component 1802, depicted in FIG. 18) may receive a plurality of first random access messages via respective UE beams associated with a network beam of the one or more respective network beams, as described above.

As further shown in FIG. 16, in some aspects, process 1600 may include transmitting an indication of a UE beam of the respective UE beams (block 1630). For example, the network node (such as by using communication manager 155 or transmission component 1804, depicted in FIG. 18) may transmit an indication of a UE beam of the respective UE beams, as described above.

Process 1600 may include additional aspects, such as any single aspect or any combination of aspects described below or in connection with one or more other processes described elsewhere herein.

In a first additional aspect, the indication is a second random access message.

In a second additional aspect, alone or in combination with the first aspect, process 1600 includes communicating one or more signals via the UE beam.

In a third additional aspect, alone or in combination with one or more of the first and second aspects, process 1600 includes transmitting an indication to transmit the plurality of first random access messages via the respective UE beams.

In a fourth additional aspect, alone or in combination with one or more of the first through third aspects, the indication indicates one or more of a first random access message transmission quantity threshold or a plurality of ROs associated with the plurality of first random access messages.

In a fifth additional aspect, alone or in combination with one or more of the first through fourth aspects, a transmit power of the plurality of first random access messages is in accordance with one or more TPC parameters associated with first random access message beam sweeping.

In a sixth additional aspect, alone or in combination with one or more of the first through fifth aspects, process 1600 includes transmitting an indication of one or more absolute values of the one or more TPC parameters.

In a seventh additional aspect, alone or in combination with one or more of the first through sixth aspects, process 1600 includes transmitting an indication of one or more differential values of the one or more TPC parameters.

In an eighth additional aspect, alone or in combination with one or more of the first through seventh aspects, a transmit power of the plurality of first random access messages is associated with a random access failure.

In a ninth additional aspect, alone or in combination with one or more of the first through eighth aspects, the transmit power of the plurality of first random access messages is greater than a transmit power of a plurality of first random access messages that were previously transmitted.

In a tenth additional aspect, alone or in combination with one or more of the first through ninth aspects, the transmit power of the plurality of first random access messages is equal to a transmit power of a plurality of first random access messages that were previously transmitted.

In an eleventh additional aspect, alone or in combination with one or more of the first through tenth aspects, the transmit power of the plurality of first random access messages is greater than a transmit power of a plurality of first random access messages that were previously transmitted via the respective UE beams, or the respective UE beams are first respective UE beams, and the transmit power of the plurality of first random access messages is equal to a transmit power of a plurality of first random access messages that were previously transmitted via second respective UE beams that are different than the first respective UE beams.

In a twelfth additional aspect, alone or in combination with one or more of the first through eleventh aspects, the plurality of first random access messages is a first plurality of first random access messages, the respective UE beams are first respective UE beams, the network beam is a first network beam, receiving the plurality of first random access messages comprises receiving the plurality of first random access messages in one or more first ROs associated with downlink UE beam selection, the UE beam is a downlink UE beam, and process 1600 includes receiving a second plurality of first random access messages via second respective UE beams associated with a second network beam of the one or more respective network beams in one or more second ROs associated with uplink UE beam selection, and transmitting an indication of an uplink UE beam of the second respective UE beams.

In a thirteenth additional aspect, alone or in combination with one or more of the first through twelfth aspects, the first network beam is different than the second network beam.

In a fourteenth additional aspect, alone or in combination with one or more of the first through thirteenth aspects, one or more indexes of the one or more first ROs are associated with one or more indexes of the one or more second ROs.

In a fifteenth additional aspect, alone or in combination with one or more of the first through fourteenth aspects, an RA-RNTI of a downlink communication that schedules a second random access message carrying the indication of the downlink UE beam and the indication of the uplink UE beam is associated with the one or more first ROs or the one or more second ROs.

Although FIG. 16 shows example blocks of process 1600, in some aspects, process 1600 may include additional blocks, fewer blocks, different blocks, or differently arranged blocks than those depicted in FIG. 16. Additionally or alternatively, two or more of the blocks of process 1600 may be performed in parallel.

FIG. 17 is a diagram of an example apparatus 1700 for wireless communication that supports beam selection with random access in accordance with the present disclosure. The apparatus 1700 may be a UE, or a UE may include the apparatus 1700. In some aspects, the apparatus 1700 includes a reception component 1702, a transmission component 1704, and a communication manager 1706, which may be in communication with one another (for example, via one or more buses). As shown, the apparatus 1700 may communicate with another apparatus 1708 (such as a UE 120, a network node 110, or another wireless communication device) using the reception component 1702 and the transmission component 1704. The communication manager 1706 may be included in, or implemented via, a processing system (for example, the processing system 140). In some aspects, the communication manager 1706 is the communication manager 150.

In some aspects, the apparatus 1700 may be configured to and/or operable to perform one or more operations described herein in connection with FIGS. 7-14. Additionally or alternatively, the apparatus 1700 may be configured to and/or operable to perform one or more processes described herein, such as process 1500 of FIG. 15.

The reception component 1702 may receive communications, such as reference signals, control information, and/or data communications, from the apparatus 1708. The reception component 1702 may provide received communications to one or more other components of the apparatus 1700, such as the communication manager 1706. In some aspects, the reception component 1702 may perform signal processing on the received communications, and may provide the processed signals to the one or more other components in a similar manner as described above in connection with FIG. 1. In some aspects, the reception component 1702 may include one or more components of the UE described above in connection with FIG. 1, such as a radio, one or more RF chains, one or more transceivers, or one or more modems, each of which may in turn be coupled with one or more antennas of the UE.

The transmission component 1704 may transmit communications, such as reference signals, control information, and/or data communications, to the apparatus 1708. In some aspects, the communication manager 1706 may generate communications and may transmit the generated communications to the transmission component 1704 for transmission to the apparatus 1708. In some aspects, the transmission component 1704 may perform signal processing on the generated communications, and may transmit the processed signals to the apparatus 1708 in a similar manner as described above in connection with FIG. 1. In some aspects, the transmission component 1704 may include one or more components of the UE described above in connection with FIG. 1, such as a radio, one or more RF chains, one or more transceivers, or one or more modems, each of which may in turn be coupled with one or more antennas of the UE. In some aspects, the transmission component 1704 may be co-located with the reception component 1702.

The communication manager 1706 may receive or may cause the reception component 1702 to receive one or more beam sweeping signals via one or more respective network beams. The communication manager 1706 may transmit or may cause the transmission component 1704 to transmit a plurality of first random access messages via respective UE beams associated with a network beam of the one or more respective network beams. The communication manager 1706 may receive or may cause the reception component 1702 to receive an indication of a UE beam of the respective UE beams. In some aspects, the communication manager 1706 may perform one or more operations described elsewhere herein as being performed by one or more components of the communication manager 1706.

The reception component 1702 may receive one or more beam sweeping signals via one or more respective network beams. The transmission component 1704 may transmit a plurality of first random access messages via respective UE beams associated with a network beam of the one or more respective network beams. The reception component 1702 may receive an indication of a UE beam of the respective UE beams. In some aspects, the reception component 1702 or the transmission component 1704 may communicate one or more signals via the UE beam. In some aspects, reception component 1702 may receive an indication to transmit the plurality of first random access messages via the respective UE beams. In some aspects, reception component 1702 may receive an indication of one or more absolute values of the one or more TPC parameters. In some aspects, reception component 1702 may receive an indication of one or more differential values of the one or more TPC parameters.

The quantity and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally or alternatively, a set of (one or more) components shown in FIG. 17 may perform one or more functions described as being performed by another set of components shown in FIG. 17.

FIG. 18 is a diagram of an example apparatus 1800 for wireless communication that supports beam selection with random access in accordance with the present disclosure. The apparatus 1800 may be a network node, or a network node may include the apparatus 1800. In some aspects, the apparatus 1800 includes a reception component 1802, a transmission component 1804, and a communication manager 1806, which may be in communication with one another (for example, via one or more buses). As shown, the apparatus 1800 may communicate with another apparatus 1808 (such as a UE 120, a network node 110, or another wireless communication device) using the reception component 1802 and the transmission component 1804. The communication manager 1806 may be included in, or implemented via, a processing system (for example, the processing system 145). In some aspects, the communication manager 1806 is the communication manager 155.

In some aspects, the apparatus 1800 may be configured to and/or operable to perform one or more operations described herein in connection with FIGS. 7-15. Additionally or alternatively, the apparatus 1800 may be configured to and/or operable to perform one or more processes described herein, such as process 1600 of FIG. 16.

The reception component 1802 may receive communications, such as reference signals, control information, and/or data communications, from the apparatus 1808. The reception component 1802 may provide received communications to one or more other components of the apparatus 1800, such as the communication manager 1806. In some aspects, the reception component 1802 may perform signal processing on the received communications, and may provide the processed signals to the one or more other components in a similar manner as described above in connection with FIG. 1. In some aspects, the reception component 1802 may include one or more components of the network node described above in connection with FIG. 1, such as a radio, one or more RF chains, one or more transceivers, or one or more modems, each of which may in turn be coupled with one or more antennas of the network node.

The transmission component 1804 may transmit communications, such as reference signals, control information, and/or data communications, to the apparatus 1808. In some aspects, the communication manager 1806 may generate communications and may transmit the generated communications to the transmission component 1804 for transmission to the apparatus 1808. In some aspects, the transmission component 1804 may perform signal processing on the generated communications, and may transmit the processed signals to the apparatus 1808 in a similar manner as described above in connection with FIG. 1. In some aspects, the transmission component 1804 may include one or more components of the network node described above in connection with FIG. 1, such as a radio, one or more RF chains, one or more transceivers, or one or more modems, each of which may in turn be coupled with one or more antennas of the network node. In some aspects, the transmission component 1804 may be co-located with the reception component 1802.

The communication manager 1806 may transmit or may cause the transmission component 1804 to transmit one or more beam sweeping signals via one or more respective network beams. The communication manager 1806 may receive or may cause the reception component 1802 to receive a plurality of first random access messages via respective UE beams associated with a network beam of the one or more respective network beams. The communication manager 1806 may transmit or may cause the transmission component 1804 to transmit an indication of a UE beam of the respective UE beams. In some aspects, the communication manager 1806 may perform one or more operations described elsewhere herein as being performed by one or more components of the communication manager 1806.

The transmission component 1804 may transmit one or more beam sweeping signals via one or more respective network beams. The reception component 1802 may receive a plurality of first random access messages via respective UE beams associated with a network beam of the one or more respective network beams. The transmission component 1804 may transmit an indication of a UE beam of the respective UE beams. In some aspects, the reception component 1802 or the transmission component 1804 may communicate one or more signals via the UE beam. In some aspects, the transmission component 1804 may transmit an indication to transmit the plurality of first random access messages via the respective UE beams. In some aspects, the transmission component 1804 may transmit an indication of one or more absolute values of the one or more TPC parameters. In some aspects, the transmission component 1804 may transmit an indication of one or more differential values of the one or more TPC parameters.

The quantity and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally or alternatively, a set of (one or more) components shown in FIG. 18 may perform one or more functions described as being performed by another set of components shown in FIG. 18.

The following provides an overview of some Aspects of the present disclosure:

Aspect 1: A method for wireless communication by a user equipment (UE), comprising: receiving one or more beam sweeping signals via one or more respective network beams; transmitting a plurality of first random access messages via respective UE beams associated with a network beam of the one or more respective network beams; and receiving an indication of a UE beam of the respective UE beams.

Aspect 2: The method of Aspect 1, wherein the indication is a second random access message.

Aspect 3: The method of any of Aspects 1-2, further comprising: communicating one or more signals via the UE beam.

Aspect 4: The method of any of Aspects 1-3, further comprising: receiving an indication to transmit the plurality of first random access messages via the respective UE beams.

Aspect 5: The method of Aspect 4, wherein the indication indicates one or more of a first random access message transmission quantity threshold or a plurality of random access channel (RACH) occasions (ROs) associated with the plurality of first random access messages.

Aspect 6: The method of any of Aspects 1-5, wherein a transmit power of the plurality of first random access messages is in accordance with one or more transmit power control (TPC) parameters associated with first random access message beam sweeping.

Aspect 7: The method of Aspect 6, further comprising: receiving an indication of one or more absolute values of the one or more TPC parameters.

Aspect 8: The method of Aspect 6, further comprising: receiving an indication of one or more differential values of the one or more TPC parameters.

Aspect 9: The method of any of Aspects 1-8, wherein a transmit power of the plurality of first random access messages is associated with a random access failure.

Aspect 10: The method of Aspect 9, wherein the transmit power of the plurality of first random access messages is greater than a transmit power of a plurality of first random access messages that were previously transmitted.

Aspect 11: The method of Aspect 9, wherein the transmit power of the plurality of first random access messages is equal to a transmit power of a plurality of first random access messages that were previously transmitted.

Aspect 12: The method of Aspect 9, wherein the transmit power of the plurality of first random access messages is greater than a transmit power of a plurality of first random access messages that were previously transmitted via the respective UE beams, or wherein the respective UE beams are first respective UE beams, and wherein the transmit power of the plurality of first random access messages is equal to a transmit power of a plurality of first random access messages that were previously transmitted via second respective UE beams that are different than the first respective UE beams.

Aspect 13: The method of any of Aspects 1-12, wherein the plurality of first random access messages is a first plurality of first random access messages, the respective UE beams are first respective UE beams, the network beam is a first network beam, transmitting the first plurality of first random access messages comprises transmitting the first plurality of first random access messages in one or more first random access channel (RACH) occasions (ROs) associated with downlink UE beam selection, and the UE beam is a downlink UE beam, the method further comprising: transmitting a second plurality of first random access messages via second respective UE beams associated with a second network beam of the one or more respective network beams in one or more second ROs associated with uplink UE beam selection; and receiving an indication of an uplink UE beam of the second respective UE beams.

Aspect 14: The method of Aspect 13, wherein the first network beam is different than the second network beam.

Aspect 15: The method of Aspect 14, wherein one or more indexes of the one or more first ROs are associated with one or more indexes of the one or more second ROs.

Aspect 16: The method of Aspect 14, wherein a random access radio network temporary identifier (RA-RNTI) of a downlink communication that schedules a second random access message carrying the indication of the downlink UE beam and the indication of the uplink UE beam is associated with the one or more first ROs or the one or more second ROs.

Aspect 17: A method for wireless communication by a network node, comprising: transmitting one or more beam sweeping signals via one or more respective network beams; receiving a plurality of first random access messages via respective user equipment (UE) beams associated with a network beam of the one or more respective network beams; and transmitting an indication of a UE beam of the respective UE beams.

Aspect 18: The method of Aspect 17, wherein the indication is a second random access message.

Aspect 19: The method of any of Aspects 17-18, further comprising: communicating one or more signals via the UE beam.

Aspect 20: The method of any of Aspects 17-19, further comprising: transmitting an indication to transmit the plurality of first random access messages via the respective UE beams.

Aspect 21: The method of Aspect 20, wherein the indication indicates one or more of a first random access message transmission quantity threshold or a plurality of random access channel (RACH) occasions (ROs) associated with the plurality of first random access messages.

Aspect 22: The method of any of Aspects 17-21, wherein a transmit power of the plurality of first random access messages is in accordance with one or more transmit power control (TPC) parameters associated with first random access message beam sweeping.

Aspect 23: The method of Aspect 22, further comprising: transmitting an indication of one or more absolute values of the one or more TPC parameters.

Aspect 24: The method of Aspect 22, further comprising: transmitting an indication of one or more differential values of the one or more TPC parameters.

Aspect 25: The method of any of Aspects 17-24, wherein a transmit power of the plurality of first random access messages is associated with a random access failure.

Aspect 26: The method of Aspect 25, wherein the transmit power of the plurality of first random access messages is greater than a transmit power of a plurality of first random access messages that were previously transmitted.

Aspect 27: The method of Aspect 25, wherein the transmit power of the plurality of first random access messages is equal to a transmit power of a plurality of first random access messages that were previously transmitted.

Aspect 28: The method of Aspect 25, wherein the transmit power of the plurality of first random access messages is greater than a transmit power of a plurality of first random access messages that were previously transmitted via the respective UE beams, or wherein the respective UE beams are first respective UE beams, and wherein the transmit power of the plurality of first random access messages is equal to a transmit power of a plurality of first random access messages that were previously transmitted via second respective UE beams that are different than the first respective UE beams.

Aspect 29: The method of any of Aspects 17-28, wherein the plurality of first random access messages is a first plurality of first random access messages, the respective UE beams are first respective UE beams, the network beam is a first network beam, receiving the plurality of first random access messages comprises receiving the plurality of first random access messages in one or more first random access channel (RACH) occasions (ROs) associated with downlink UE beam selection, and the UE beam is a downlink UE beam, the method further comprising: receiving a second plurality of first random access messages via second respective UE beams associated with a second network beam of the one or more respective network beams in one or more second ROs associated with uplink UE beam selection; and transmitting an indication of an uplink UE beam of the second respective UE beams.

Aspect 30: The method of Aspect 29, wherein the first network beam is different than the second network beam.

Aspect 31: The method of Aspect 30, wherein one or more indexes of the one or more first ROs are associated with one or more indexes of the one or more second ROs.

Aspect 32: The method of Aspect 30, wherein a random access radio network temporary identifier (RA-RNTI) of a downlink communication that schedules a second random access message carrying the indication of the downlink UE beam and the indication of the uplink UE beam is associated with the one or more first ROs or the one or more second ROs.

Aspect 33: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-32.

Aspect 34: An apparatus for wireless communication at a device, the apparatus comprising one or more memories and one or more processors coupled to the one or more memories, the one or more processors configured to cause the device to perform the method of one or more of Aspects 1-32.

Aspect 35: An apparatus for wireless communication, the apparatus comprising at least one means for performing the method of one or more of Aspects 1-32.

Aspect 36: A non-transitory computer-readable medium storing code for wireless communication, the code comprising instructions executable by one or more processors to perform the method of one or more of Aspects 1-32.

Aspect 37: A non-transitory computer-readable medium storing a set of instructions for wireless communication, the set of instructions comprising one or more instructions that, when executed by one or more processors of a device, cause the device to perform the method of one or more of Aspects 1-32.

Aspect 38: A device for wireless communication, the device comprising a processing system that includes one or more processors and one or more memories coupled with the one or more processors, the processing system configured to cause the device to perform the method of one or more of Aspects 1-32.

Aspect 39: An apparatus for wireless communication at a device, the apparatus comprising one or more memories and one or more processors coupled to the one or more memories, the one or more processors individually or collectively configured to cause the device to perform the method of one or more of Aspects 1-32.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
a processing system that includes one or more processors and one or more code-storing memories coupled with the one or more processors, the processing system configured to cause the UE to:
receive one or more beam sweeping signals via one or more respective network beams;
transmit a plurality of first random access messages via respective UE beams associated with a network beam of the one or more respective network beams; and
receive an indication of a UE beam of the respective UE beams.

2. The apparatus of claim 1, wherein the indication is a second random access message.

3. The apparatus of claim 1, wherein the processing system is further configured to cause the UE to:
communicate one or more signals via the UE beam.

4. The apparatus of claim 1, wherein the processing system is further configured to cause the UE to:
receive an indication to transmit the plurality of first random access messages via the respective UE beams.

5. The apparatus of claim 4, wherein the indication indicates one or more of a first random access message transmission quantity threshold or a plurality of random access channel (RACH) occasions (ROs) associated with the plurality of first random access messages.

6. The apparatus of claim 1, wherein a transmit power of the plurality of first random access messages is in accordance with one or more transmit power control (TPC) parameters associated with first random access message beam sweeping.

7. The apparatus of claim 6, wherein the processing system is further configured to cause the UE to:
receive an indication of one or more absolute values of the one or more TPC parameters.

8. The apparatus of claim 6, wherein the processing system is further configured to cause the UE to:
receive an indication of one or more differential values of the one or more TPC parameters.

9. The apparatus of claim 1, wherein a transmit power of the plurality of first random access messages is associated with a random access failure.

10. The apparatus of claim 9, wherein the transmit power of the plurality of first random access messages is greater than a transmit power of a plurality of first random access messages that were previously transmitted.

11. The apparatus of claim 9, wherein the transmit power of the plurality of first random access messages is equal to a transmit power of a plurality of first random access messages that were previously transmitted.

12. The apparatus of claim 9, wherein the transmit power of the plurality of first random access messages is greater than a transmit power of a plurality of first random access messages that were previously transmitted via the respective UE beams, or
wherein the respective UE beams are first respective UE beams, and wherein the transmit power of the plurality of first random access messages is equal to a transmit power of a plurality of first random access messages that were previously transmitted via second respective UE beams that are different than the first respective UE beams.

13. The apparatus of claim 1, wherein the plurality of first random access messages is a first plurality of first random access messages, the respective UE beams are first respective UE beams, the network beam is a first network beam, to cause the UE to transmit the first plurality of first random access messages, the processing system is configured to cause the UE to transmit the first plurality of first random access messages in one or more first random access channel (RACH) occasions (ROs) associated with downlink UE beam selection, the UE beam is a downlink UE beam, and the processing system is configured to cause the UE to:
transmit a second plurality of first random access messages via second respective UE beams associated with a second network beam of the one or more respective network beams in one or more second ROs associated with uplink UE beam selection; and
receive an indication of an uplink UE beam of the second respective UE beams.

14. The apparatus of claim 13, wherein the first network beam is different than the second network beam.

15. The apparatus of claim 14, wherein one or more indexes of the one or more first ROs are associated with one or more indexes of the one or more second ROs.

16. The apparatus of claim 14, wherein a random access radio network temporary identifier (RA-RNTI) of a downlink communication that schedules a second random access message carrying the indication of the downlink UE beam and the indication of the uplink UE beam is associated with the one or more first ROs or the one or more second ROs.

17. An apparatus for wireless communication at a network node, comprising:
a processing system that includes one or more processors and one or more code-storing memories coupled with the one or more processors, the processing system configured to cause the network node to:
transmit one or more beam sweeping signals via one or more respective network beams;
receive a plurality of first random access messages via respective user equipment (UE) beams associated with a network beam of the one or more respective network beams; and
transmit an indication of a UE beam of the respective UE beams.

18. The apparatus of claim 17, wherein the indication is a second random access message.

19. The apparatus of claim 17, wherein the processing system is further configured to cause the network node to:
communicate one or more signals via the UE beam.

20. The apparatus of claim 17, wherein the processing system is further configured to cause the network node to:
transmit an indication to transmit the plurality of first random access messages via the respective UE beams.

21. The apparatus of claim 20, wherein the indication indicates one or more of a first random access message transmission quantity threshold or a plurality of random access channel (RACH) occasions (ROs) associated with the plurality of first random access messages.

22. The apparatus of claim 17, wherein a transmit power of the plurality of first random access messages is in accordance with one or more transmit power control (TPC) parameters associated with first random access message beam sweeping.

23. The apparatus of claim 22, wherein the processing system is further configured to cause the network node to:
transmit an indication of one or more absolute values of the one or more TPC parameters.

24. The apparatus of claim 22, wherein the processing system is further configured to cause the network node to:
transmit an indication of one or more differential values of the one or more TPC parameters.

25. The apparatus of claim 17, wherein a transmit power of the plurality of first random access messages is associated with a random access failure.

26. The apparatus of claim 25, wherein the transmit power of the plurality of first random access messages is greater than a transmit power of a plurality of first random access messages that were previously transmitted.

27. The apparatus of claim 25, wherein the transmit power of the plurality of first random access messages is equal to a transmit power of a plurality of first random access messages that were previously transmitted.

28. The apparatus of claim 25, wherein the transmit power of the plurality of first random access messages is greater than a transmit power of a plurality of first random access messages that were previously transmitted via the respective UE beams, or
wherein the respective UE beams are first respective UE beams, and wherein the transmit power of the plurality of first random access messages is equal to a transmit power of a plurality of first random access messages that were previously transmitted via second respective UE beams that are different than the first respective UE beams.

29. A method for wireless communication by a user equipment (UE), comprising:
receiving one or more beam sweeping signals via one or more respective network beams;
transmitting a plurality of first random access messages via respective UE beams associated with a network beam of the one or more respective network beams; and
receiving an indication of a UE beam of the respective UE beams.

30. A method for wireless communication by a network node, comprising:
transmitting one or more beam sweeping signals via one or more respective network beams;
receiving a plurality of first random access messages via respective user equipment (UE) beams associated with a network beam of the one or more respective network beams; and
transmitting an indication of a UE beam of the respective UE beams.
